(19) United States
(12) Patent Application Publication
(10) Pub. No.: US 2004/0112299 A1
(43) Pub. Date: Jun. 17, 2004

(54) Incorporation of competitive effects in breeding program to increase performance levels and improve animal well being

(76) Inventor: William M Muir, West Lafayette, IN (US)

Correspondence Address: JONDLE & ASSOCIATES P.C., 9085 EAST MINERAL CIRCLE, SUITE 200, CENTENNIAL, CO, 80112, US

(21) Appl. No.: 10/472,774

(22) PCT Filed: Mar. 25, 2002
(86) PCT No.: PCT/US02/09098

(51) Int. Cl. A01K 29/00

(52) U.S. Cl. 119/174

(57) ABSTRACT

The present invention is directed to a method for improving the efficiency of a breeding program that has as its goal to alter desired traits which are influenced by competitive effects.

### CROSS-REFERENCE

This application claims priority to U.S. Provisional Application, Serial No. 60/277,970, filed Mar. 23, 2001; U.S. Provisional Application, Serial No. 60/277,971, filed Mar. 23, 2001; and U.S. Provisional Application, Serial No. 60/277,972, filed Mar. 23, 2001.

### BACKGROUND

Competition and cannibalism have major impacts on productivity and yield of all species of plants and animals raised commercially. In some cases, such effects prevent commercial production in confined setting, such as with shell (lobsters, prawns, and crayfish) and game fish. Even with domesticated species such as swine, such competitive effects can reduce profits by as much as 50%, costing billions of dollars in the swine industry. In poultry layers, birds are beak trimmed to control injury and death from beak inflicted injuries. However, beak trimming in itself compromises animal well-being. Among plant, competition for light and nutrient resources also limit productivity of a stand or plot. Methods are necessary to domesticate species, which are competitive or cannibalistic, while at the same time increase productivity. Current methods of plant and animal breeding ignore competitive effects in their selection objective. If higher producing animals tend to be more competitive; the effect of selection is to increase competition. Competition has the effect of lowering productivity of other animals that are in direct contention.

Over the past five decades the art of animal breeding has rapidly advanced into an exacting science with such developments as best linear unbiased prediction (BLUP) estimation of breeding values and the restricted maximum likelihood (REML) estimates of variance components. These methods promise much faster advances in genetic improvement than previously possible. However, actual responses have often fallen short of expectation and in some cases responses were worse than with previous methods. The reason for these disappointing results can only be due to assumptions inherent to the BLUP models used. The most commonly used and recognized assumption is that of an additive model, i.e. no dominance or higher order epistasis. However, a more important, and less recognized, assumption is that of non-interacting genotypes, i.e. genotypes do not compete. If higher producing animals tend to be more competitive; the effect of selection is to increase competition. Competition has the effect of lowering productivity of other animals that are in direct contention. As such, ignoring competitive interactions invalidates the traditional BLUP model used (commonly referred to as Animal Model BLUP, or AM-BLUP) and negates any advantages of this technology and could in fact make it a liability. This loss includes only costs due to reduced rate of gain and ignores the increased cost such as for building facilities, small group pens, beak trimming, low intensity lighting and controlling, cold, heat, handling and social stress, employed as management practices to control competitive interactions.

Although all breeding of plants and animals occurs in some type of groups (pens, fields, or areas), current breeding theory states that individuals should be assigned to those groups at random to avoid confounding genetic effects with non-genetic environmental effect particular to each group (referred to as common environmental or c² effects). An alternative to individual selection is group or kin selection. Traditional group selection requires that the groups be non-random and composed of related individuals and also requires that entire groups be selected or culled for breeding purposes.

Group selection has been proven as a method which will accomplish these goals. Half-sib family selection conducted with poultry layers was highly effective in reducing competitive interactions while increasing productivity. However, traditional group selection greatly increases the rate of inbreeding to levels generally unacceptable in long term breeding programs and limits long term genetic gain. Given that competitive interactions are of major importance, a breeding program which takes competition into account while reducing the rate of inbreeding inherent in the family selection, would be of major importance in the genetic improvement of animals and plants.

Selection Based on Individual Performance

Emsley et al. (1977) estimated genetic correlations between egg production and flightiness score which indicated that greater excitability was mildly associated with higher rates of lay. From these parameters, Kashyap et al. (1981) developed a selection index for aggregate economic gain which includes a number of traits but gave positive weight to egg number and negative to excitability or flightiness, which nevertheless resulted in a positive response in excitability. Further examination of the data collected by Kashyap et al. (1981) showed that genetic changes in excitability were greater than what would have been predicted by theory (Bennett et al., 1981). However, their results are in agreement with the theories of Griffing (1967).

Craig and Lee (1989) detected a strong genotype by beak-treatment interaction for egg mass per hen housed among three commercial lines. From 32-36 wk of age, the genotype which produced the greatest egg mass with beak treatment produced the least with intact beaks. The re-ranking was shown to be due to mortality from beak inflicted injuries. Choudary et al. (1972) compared four commercial lines of poultry and found that the line which had the highest hen day rate of lay had the lowest hen housed rate of lay due to high mortality. These results tend to confirm Griffing's (1967) theories because productivity and mortality were negatively correlated.

Lee and Craig (1981a,b) found that a stock which was selected for increased productivity had greater feather loss than its unselected control when kept in 3-bird cages. Craig et al. (1975) compared aggressive behavior among lines of chickens selected for part record egg production under competitive conditions and the non-selected control from which the selected lines were derived. Results generally showed that artificial selection had increased aggressiveness and social dominance in the adolescent period. Results from Lowry and Abplanalp (1970, 1972) showed that strains selected under floor flock conditions became socially dominant to both those selected in single bird cages and unselected controls. Craig et al. (1965) and Craig and Toth (1969) showed that hens of lines selected for social dominance had lower rates of lay than did hens of the same line selected for low social dominance. In addition, Craig (1970) showed that the high social dominance line withstood crowding less well than the low social dominance line. However, in single bird cages egg production of the high line was superior to that of the low. Biswas and Craig (1970) also showed that the high strain hens had much lower production than the low line in floor pens or multiple-bird cages but were equally productive in single-bird cages.

Selection Based on Group Performance

The earliest experiment reported with chickens using kin selection to improve adaptability to social stress was unsuccessful (Craig, 1982). In retrospect, Craig (1994) concluded that the failure may have been due to the relatively benign environments in which the hens had been kept during selection, i.e. beak trimmed, relatively low density and part-record egg production. Craig (1982) states that with kin selection practices such as beak trimming, dim lighting, and declawing should be abandoned so that such tendencies toward feather and cannibalistic pecking and claw-inflicted injuries could be revealed.

Muir (1996) examined the use of group selection for adaptation of hens to multiple-hen cages-. His selection experiment was initiated with a synthetic line of White Leghorns in 1982 to improve adaptability and well-being of layers in large multiple-bird cages. With this procedure, each sire family was housed as a group in a multiple-bird cage and selected or rejected as a group. An unselected control, with approximately the same number of breeders as the selected line, was maintained for comparison and housed in one-bird cages. Annual percentage mortality of the selected line in multiple-bird cages decreased from 68% in Generation (G)2 to 8.8% in G6. Percentage mortality in G6 of the selected line in multiple-bird cages was similar to that of the unselected control in one-bird cages (9.1%). Annual days survival improved from 169 to 348 d, eggs per hen per day (EHD) from 52 to 68%, eggs per hen housed from 91 to 237 eggs, and egg mass (M) from 5.1 to 13.4 kg, whereas annual egg weight remained unchanged. The dramatic improvement in livability demonstrates that adaptability and well-being of these birds were improved by group selection. The similar survival of the selected line in multiple-bird cages and the control in one-bird cages suggests that beak-trimming of the selected line would not further reduce mortality, which implies that group selection may have eliminated the need to beak-trim. Corresponding improvements in EHD and EM demonstrate that such changes can also be profitable: The most surprising finding was the rate at which such improvement took place, with the majority of change in survival occurring by the third generation. However, EHD continued to improve at the rate of 4% per generation. This line of improved birds was termed the Kindler Gentler Bird (KGB).

At the fourth generation of selection, Kuo et al. (1991) and Craig and Muir (1991) compared performance of the selected and control lines in 6-bird cages with 387 cm2 floor space per bird from 16 to 36 wk of age with 0, ½, or ⅔ of the beak trimmed. Results showed a highly significant beak-treatment by genetic stock interaction for hen housed rate of lay, daily egg mass, and mortality. With intact beaks, the selected line had a significantly higher egg production, egg mass, and survival. With ⅔ of the beak removed, difference in egg production and egg mass remained significantly different but the magnitude of difference had declined. Further, mortality was not significantly different Egg weights of the selected line were slightly higher than that of the control but not significantly so.

Muir and Craig (1998) and Craig and Muir (1996) compared the KGB line to a commercial strain (X), and a random bred control (C) from which the KGB stock was derived. The three stocks of White Leghorns were compared for behavioral traits when kept in single-bird (1H) and 12-hen (12H) layer-house cages. Experimental units consisted of four consecutive 1H cages or a single 12H cage. All birds within a unit had intact beaks and were of the same stock. Each stock was represented by hens in 48 units of both 1H and 12H cages, and by 48 males (C and S stocks only) in 1H cages. Birds that died were replaced. Observations involved hens in their home cages except for tonic immobility (TI) and pair contests. Observations of hens agonistic activity in the 12H cage environment revealed that the KGB stock had fewer agonistic acts than the C stock from which it was derived, and both C and KGB had less agonistic activity than the X stock. Mortality from beak-inflicted injuries differed among stocks in total hens lost (P <0.005). Of 576 per stock in 12H cages 287, 128, and 46 replacements were used from 17 to 44 wk in X, C, and KGB, respectively, to maintain group size. The C and KGB hens also differed from 44 to 59 wk and 17 to 59 wk. X hens were not included in comparisons of mortality beyond 44 wk, Relative incidence of mortality caused by vent-cloacal injuries differed with X>C=S (P<0.005 for X vs C and KGB). For cages with greater than or equal to 1 cannibalistic death, X had twice (P<0.025) and C 1.6 times (P<0.10) as many with repeated losses as KGB. Greater variances were observed in 12H cages and among older birds. Within 1H units, genetic stocks did not differ in general, but in 12H cages X and C were always more variable than KGB. In 12H cages, mean feather scores and body weights were decreased and KGB hens had better feathering than either C or X. Egg production before, during, and after heat stress indicated that the selected line withstood social, handling, and environmental stress better than the control line and in come cases the commercial (Muir, 1998).

Hester et al. (1996b) compared the KGB bird to the unselected control and a commercial strain under both stressed and unstressed conditions. The three Lines of chickens (selected, control, and commercial) were housed in either single-hen (1 hen) or multiple-hen cages (12 hens, social competition) at 16.7 or 17.1 wk of age. They were subsequently subjected to cold exposure at 33 wk of age and heat exposure at 44 wk of age. At the time of transfer to laying cages, the selected line of pullets, as indicated by a decrease in packed cell volume, appeared to adapt more quickly to the new waterer system of multiple-hen cages than did the control and commercial lines. At 33 wk of age, the control and commercial lines in multiple-hen cages experienced heterophilia and increased heterophil to lymphocyte ratios, whereas the selected line did not, when compared with these same lines in single-hen cages. This leucocytic response was interpreted to mean that the selected line of chickens adapted better to social competition than either the control or commercial lines. The physiological characterization of the KGB line of Leghorns showed evidence of improved adaptation to multiple-hen cages when compared to the other stocks. In some cases, the selected line responded less intensely to stress. Hester et al. (1996b) comparing the same three lines showed that the KGB line of chickens in multiple-hen cages showed an increased resistance to heat exposure, as indicated by lower mortality, when compared to the control and commercial lines housed in multiple-hen cages. Egg production 8 d prior to, during, and 8 d following either cold or heat exposures indicated that the selected Line of-chickens withstood social, handling, and environmental stressors better than the control line and, in some cases, the commercial line of chickens. It was concluded that the KGB line of Leghorns showed evidence of stress resistance through lowered mortality and improved production.

Taken as a whole, these results present conclusive evidence that group selection on the traits rate of lay and longevity is effective in improving well-being of layers in a relatively short period of time without sacrificing productivity. The way for commercial breeders to develop birds which do not need beak trimming is clear. Further, because group selection is shown to improve well-being in multiple-bird cages, alternatives such as redesigning cage environments, or housing such as floor pens or free ranges, may not be needed.

Research on effect of competition on growth of swine were conducted by Frank et al.. (1997a). In this experiment group size was increased from one pig per pen to multiple pigs in increment steps while keeping density (space per pig) and feeder space constant Results of this experiment show that as group size increased, percent fat increased by about 12% (FIG. 1), while average daily gain decreased 7% (FIG. 2). The cumulative effect of reduced gain and increased fat reduced feed conversion by about 6% FIG. 3).

An even more dramatic effect was shown by Holck et al. (1997), however in their study the effect of group size was confounded with rearing environment and density. The housed barrows in either a commercial grow-finish facility with 24 pigs/pen and 0.74 m2/pig space or 3 pigs/pen and 2.23 m2/pig. The average daily gain of pigs in pigs in group sizes of 3 was 42% greater than those in groups of 2. These two studies clearly show that competition has a major impact on growth in swine.

The publications, patents and other materials used herein to illuminate the background of the invention, and in particular cases, to provide additional details respecting the practice, are incorporated by reference, and for convenience are referenced in the following text by author and date and are listed alphabetically by author in the appended bibliography .

### SUMMARY OF THE INVENTION

The present invention relates generally to the incorporation of competitive effects in breeding programs for animals and plants to achieve improvement in a desired trait, while controlling the rate of inbreeding. More specifically, alternatives to group selection were discovered that allow for individual selection, thus reducing the rate of inbreeding, while at the same time improving productivity of the group by reducing competitive effects.

In one aspect, the present invention provides a breeding method, wherein the individuals to be mated are randomly assigned to groups, trait performance is measured for the individuals in the group, and selection for breeding is by individual based on a mixed model, including two random effects, one for the direct effect of the individual (direct effect) and another for the associative effect of other individuals in the group (associative effect).

In one embodiment of this aspect, the genetic parameters include direct effects, associative effects, covariance of direct and associative effects and environmental effects. In another embodiment, the direct and associative effects are weighted using an index in order to determine the individual offspring to be selected for further breeding. In a further embodiment of this aspect of the invention, the index for weighting the direct and associative effects can be determined optimally for maximum rate of improvement of group performance by inclusion of genetic parameters for covariance between parent's direct and associative effects with their offspring's genotype.

In another aspect, the present invention provides a breeding method wherein the individuals to be mated are in family groups, trait performance is measured for the individuals in the group, and selection for breeding is by individual, based on a mixed model, including one random effect for the direct effect of the individual.

In one embodiment of this aspect, the family group is composed of full-siblings.

In another embodiment, the family group is composed of half-siblings.

In a further embodiment of this aspect, genetic parameters include environmental effects.

In a further aspect, the present invention provides a breeding method wherein the individuals to be mated are in family groups, trait performance data is measured collectively as a group, and selection for breeding is by group based on group performance data and a mixed model, including one random effect for the group mean.

In one embodiment of this aspect, genetic parameters include environmental effects.

In another embodiment of this aspect, the family group is composed of full-siblings.

In a further embodiment, the family group is composed of half-siblings.

Yet a further aspect of the present invention is a breeding method computer software that accepts breeding data, performs analysis of the breeding data, and generates output data that specifies individuals or groups of individuals to be mated. It should be recognized that the inputs and outputs may be according to any of the aspects of the present invention.

This method is applicable to all plant and animal species in which individuals can be segregated into interacting groups (common areas, such as pens, plots or fields), pedigree records maintained, and performance of the individuals recorded. Other individuals whose performance is not recorded and who were not in such groups (such as roosters for egg production), can be selected based on their relative's information for which records were obtained.

### DESCRIPTION OF THE FIGURES

FIG. 1 shows an example of a pedigree.

FIG. 2 shows random assignment of pigs to three pens.

FIG. 3 shows an example of interaction between animals.

FIG. 4 shows a flowchart for the CE-BLUP model of the present invention. These procedures may be implemented on a computer.

FIG. 5 shows a flowchart for the FGAM-BLUP model of the present invention. These procedures may be implemented on a computer.

FIG. 6 shows the G-BLUP model of the present invention. These procedures may be implemented on a computer.

FIG. 7 shows a detailed flowchart for the method of the present invention. This detailed flowchart shows the preparatory steps, inputs, operations performed on inputs and outputs.

FIG. 8 shows results of the quail density experiment of Example 3.

FIG. 9 shows results of the quail density experiment of Example 3.

FIG. 10 shows raw data of 6-week weight by hatch by selection method.

FIG. 11 shows associative effects from AM-BLUP and CE-BLUP.

FIG. 12 shows associative effects from CE-BLUP and AM-BLUP.

FIGS. 13A-C show the direct effects from use of CE-BLUP, FGAM-BLUP and AM-BLUP and results of the experiment of Example 4.

FIG. 14 shows group performance under strong competitive effects.

FIG. 15 shows group performance under weak competitive effects.

### DETAILED DESCRIPTION OF THE INVENTION

In order to address the problems associated with competitive effects and excessive inbreeding associated with family groups, a three-step approach was discovered. A theory for the new method was first described, a method for estimating genetic parameters and effects was then derived. A computer simulation was developed to test the theory and demonstrated that the method should be effective in accomplishing the goal of improving productivity of the group by reducing competitive effects. Sensitivity analysis showed the method was robust to parameter estimates. A biological test of theory was conducted using Japanese quail. Results demonstrated that current state of the art selection methods (AM-BLUP with individuals assigned randomly to groups) were ineffective in increasing genetic gain while the novel methods of the present invention were able to increase rate of response between 696% and 1074% as compared to current state of the art.

Early research with poultry layers showed that group selection based on performance of half-sib groups reared together (family selection) was highly effective in reducing competitive interactions while increasing productivity. However, family selection greatly increases the rate of inbreeding to levels generally unacceptable in long term breeding programs. In one embodiment, the method of the present invention provides an alternative to group selection by expanding the traditional BLUP model (AM-BLUP) to include not only the direct effects of the animal but the associative (competitive) effects on other animals and the covariance between the effects. With this method of the present invention, individuals are assigned to groups at random). This procedure is referred to as the Competitive Effects BLUP model (CE-BLUP). An embodiment alternative incorporates associative effects in which group structure (full- or half-sib family) is used to control for competitive interactions allowing AM-BLUP model to be used. This procedure is referred to as Family Group Animal Model BLUP (FGAM-BLUP). In both of these procedures, individuals rather than groups are selected, thereby resulting in a much lower rate of inbreeding.

Response to selection using the method of the present invention, AM-BLUP, CE-BLUP, and FGAM-BLUP, were compared in the simulation program of the present invention. Results indicated that in the presence of competition, strong or weak, FGAM-BLUP and CE-BLUP were superior to AM-BLUP. If competitive effects were strong, CE-BLUP produced superior results over FGAM-BLUP and the reverse if competitive effects were weak. However, CE-BLUP requires estimation of three times as many genetic parameters as FGAM-BLUP. As such, the advantage of CE-BLUP may be dependent on accurate estimates of parameters.

Simulations were conducted to determine if the advantage of CE-BLUP was dependent on accurate estimates of parameters. Results showed that superiority of CE-BLUP over FGAM-BLUP and AM-BLUP was robust to parameter estimates but only if competitive interactions were strong. If competitive interactions were weak, FGAM-BLUP was superior to CE-BLUP and AM-BLUP over a wide range of parameter estimates. Therefore, FGAM-BLUP represents a no risk method to account for competitive interactions in selection programs, i.e. in the absence of competitive interactions, the procedure works as well as AM-BLUP but in the presence of competitive interactions it is superior.

Verification of the theory and simulations with a model organism (quail) was initiated in October 1997 to test predictions of the model in a more realistic setting. In that experiments, the three methods of selection (CE-BLUP, FGAM-BLUP, and AM-BLUP) were compared. Weak competitive interactions were induced by giving animals nearly unlimited access to feeder space. We expected FGAM-BLUP to be superior in this setting with CE-BLUP next, and AM-BLUP is expected to give the worst results and may actually give a negative response.

From the theories of Griffing (1967), one would expect to see a negative effect on well-being under competitive conditions with direct selection for productivity based on performance of the individual. There is abundant evidence to support this conclusion as indicated below.

Definitions

In the description that follows, a number of terms are used extensively. The following definitions are provided in order to more fully understand the invention

“Associative effect” and “competitive effect” when used in relation to phenotype, refer to an effect of one individual on performance of another individual in a group, due to effects, such as active aggression in animals, or passive competition for limited resources, such as sunlight or nutrients in plants. When used to refer to genotype, associative effects are effects of genes in one individual on performance of a desired trait in another individual. Associative and competitive effects may be categorized as weak or strong. Weak associative and competitive effects are those which account for less than approximately 1% of the genetic variance for the trait. Strong associative competitive effects are those which account for approximately 5% or more of the genetic variance for the trait.

“Best linear unbiased prediction” and “BLUP” refer to an estimation method for genetic worth of a plant or animal, i.e., the best estimate of the genetic worth of an individual, wherein a mixed statistical model equation relates performance of all individuals in a pedigree with performance records for some or all traits to all other individuals with pedigree records, with or without performance records for some or all traits. The method uses all information from all relatives to determine the best estimate of the true breeding values of all individuals. The method is dependent on genetic parameters to be able to separate environment effects from other effects in the model. The method is based on maximum likelihood solutions assuming a normal distribution of effects. The traditional BLUP model is based on a mixed statistical model with one random effect for the additive genetic effect of the individual, fixed effects for herd, year, season or pen effects, plus a random error term.

“Collecting data collectively as a group” refers to collecting data for all individuals in the group and combining data to develop a group average and assigning the group average as the performance of each individual in the group.

“Common areas” refer to common pens, cages or fields used for grouping individuals. For plants, such as trees, this means that it is known which trees were in relation to each other and at what distance, i.e., which ones may have competed for limited resources.

“Competitive Effects-BLUP” and “CE-BLUP” refers to a selection method for genetic improvement which expands traditional mixed statistical model (AM-BLUP) to include both direct effects and associative effects and the covariance between the effects with selection of individuals to control inbreeding. Resulting BLUP solutions estimate both the individual direct genetic breeding value and the individual associative breeding value, i.e., the genetic effect it will have on others in a group into which it is placed. Individuals are assigned to groups randomly.

“Desired density” refers to the amount of space provided per individual in a common area. With plants, it is the spacing between plants or between rows. With animals, it is the area of the cage or pen divided by the number of animals.

“Direct effect” refers to effect of the individual's own genes directly on performance of desired traits of said individual.

“Family Group Animal Model BLUP” and “FGAM-BLUP” refer to a selection method for genetic improvement which uses a AM-BLUP model with individuals assigned to groups by full or half-sib family, selection is of individuals.

“Family selection” refers to group selection based on performance of family groups reared together. A family is any related set of individuals, full and half sibs being one example but could include more extended family relationships. G-BLUP is family selection where BLUP is used on family means.

“Full sib” refers to individuals who share both parents in common.

“Genetic covariance” is a result of pleiotropic effects of genes on two or more traits and causes the traits to co-vary. The covariance can be either positive or negative.

“Genetic parameters” refer to variance and covariance components explaining the proportion of the variation in a trait due to different sources, such as direct genetic variance, associative genetic variance, and covariance between effects, and for reference includes the environmental variance. In some situations, the genetic parameters may be given as a ratio of genetic to environmental variance.

“Group BLUP” and “G-BLUP” refer to family selection where BLUP methodology are used on family means. Performance is measured on a group basis and selection is on a group basis.

“Group Selection” refers to selection based on performance of the group average rather than on each of the individuals within the group. Selection is also by group rather than individuals within group.

“Half-sib” refers to individuals who only share on parent in common.

“Heritability” refers to the proportion of the variation in a trait which is due to additive genetic variation.

“Individual own performance” refers to selection based only on information that came from the individual, i.e., no information from relatives.

“Mixed model” and “Mixed statistical model” refer to a statistical model which includes both fixed and random effects. The fixed effects are due to identifiable sources such as herd, year, season, location, pen, and hatch. Fixed effects do not have a distribution. Random effects include those effects which are random in nature (have a distribution) and can be ascribed to a cause, such as genetics. When causes are ascribed to genetics, the pedigree is necessary to relate those effects with records of the relatives. Genetic causes can be simply additive or further subdivided into multiple random effects, such as additive, and dominance, or additive direct and additive associate effects. The solutions to the mixed model equations are dependent on the variance covariance structure among and within the random effects. The variance-covariance structure is determined by the pedigree and genetic parameters associated with each trait. Solution to the mixed model equations gives BLUP estimates of the random effects. There is one effect estimated for each random effect in the model for each individual.

“Performance data” refers to data collected on any traits of the individual, whether or not they are the objects of selection.

“Phenotype” refers to the detectable characteristics of a cell or organism, which characteristics are the manifestation of gene expression.

“Restricted maximum likelihood” and “REML” refer to a method of estimating genetic parameters.

“Selection based on group performance” refers to selection decisions made based on the group averages, ignoring individual difference within the group.

“Selection based on individual performance” refers to selection decisions based on variation among individuals. Individuals are selected.

“Uniquely identify as to parentage” refers to tracing an individual's ancestry to both parents.

To “update genetic parameters” refers to including additional information from subsequent generations of performance data, with the intent to obtain more precise estimates of genetic parameters.

“Within line” refers to difference or variation between individuals within a breed as opposed to between lines or breed.

Development of the Model of the Present Invention.

A. Selection in Groups.

Siegel (1989) considered adaptability to be an individual's ability to adapt to its environment He concluded that individuals that adapt have a higher probability of contributing genes to subsequent generations than those that do not This concept emphasizes the individual. However, if an individual adapts to its environment by eating its cagemates, survival of the individual is maximized, as is probably production, but doubtfully that of the group.

There are numerous ways that performance of one individual can influence that of another. Accommodation for such interactions presents an insurmountable dilemma from the point of view of classical (non-interaction) quantitative genetic methodology. Griffing (1967) recognized that with competition, the usual gene model for a given genotype must be extended to include not only the direct effects of its own genes, but also the associate contributions from other genotypes in the group. The problem is to optimize production of a given genotype in a competitive environment As a consequence of interacting genotypes, the same genotype can have different expressions in populations having different population structures.

Griffing (1967) extended selection theory to take into consideration interactions of genotypes. The conceptual biological model was extended to define the group and the usual model was extended to include not only direct effects of its own genes, but also associate contributions from other genotypes in the group.

In the presence of interacting genotypes the expected change in the mean from individual selection is

$$Δμ = ( i / σ ) [ {}_{d}^{}{σ}{}_{A}^{2} + ( da ) {σ}_{A}^{2} ]$$

Where

$${}_{d}^{}{σ}{}_{A}^{2}$$

is the additive variance of the direct effects and _{(da)}σ²_{A} is the additive covariance between direct and associative effects. If the covariance is negative, as occurs when there is competition for a limited resource, then selection based on individual performance can have a reverse effect on the mean, i.e. positive selection will reduce rather than increase the mean. This results because a gene which has a positive direct advantage for the individual has a negative associate effect on the group. The prediction of this theory, that individual selection will have a negative impact on the group, is evident from the previous section.

In contrast, if the group is defined as the unit of selection, then

$$Δμ = ( i / σ ) [ {}_{d}^{}{σ}{}_{A}^{2} + 2 ( da ) {σ}_{A}^{2} + {}_{a}^{}{σ}{}_{A}^{2} ]$$

where

$${}_{a}^{}{σ}{}_{A}^{2}$$

is the additive variance for associate effects in this case Δμ is always positive. Thus, transferring selection from the individual to the group ensures that the population mean will not decrease. As group size increases, associate effects take on-an increasingly dominant role in determining the consequences of selection and implies that even for weakly competitive conditions, a negative response to selection can occur. This result was shown by Muir (1985) who demonstrated a significant genotype by group size interaction between single and 9-bird cages but not between single and 4-bird cages, holding density constant.

Griffing (1967) showed that the rate of progress with groups composed of random individuals is slow and decreases as the group size increases. However, if the group is composed of related individuals the efficiency is greatly increased, particularly as group size increases (Griffing, 1976). Consideration of the interaction of relatives is important in understanding the evolution of social behavior (Hamilton, 1964). However, individual selection is still possible by use of a progeny test consisting of sib offspring housed as a group. This procedure is particularly amenable to reciprocal recurrent selection (RRS) where a progeny test is already necessary.

It is also of special note that Griffing (1967) shows that selection only on associate components cannot guarantee a positive response to selection, i.e. selection for reduced aggression will not ensure that production will increase.

There is limited, but ample, experimental evidence to support Griffing's (1967) theory. The first experiment was that of Goodnight (1985) who showed that leaf area of Arabidopsis thaliana would respond to group but not individual selection. The first experiment to use group selection with chickens was unsuccessful (Craig et al., 1982). Craig (1994) reflected that the reason for lack of response was because he had not provided an environment in which the hidden genetic variability could be expressed, i.e. he beak trimmed hens, density was low, and only a part record was used.

The first successful experiment with group selection in poultry was initiated in 1981 at Purdue University. After 4 generations of group selection based on half-sister families housed initially in groups of 9 and later in groups of 12, performance was compared between the selected and control lines in 6-hen cages with 387 cm² floor space per bird from 16 to 40 and 16 to 36 weeks of age, respectively, by Kuo et al. (1991) and Craig and Muir (1991). In the second study a stock derived from a competitive commercial stock by two generations of relaxed selection was included also. In both experiments, hens had their beaks left intact or beaks were trimmed to two different lengths.

Results of the first study showed highly significant beak-treatment by genetic stock by age interactions for hen-housed rate of lay and daily egg mass; as mortality from cannibalism increased dramatically with age in the control, but not in the selected stock, differences between the selected and control became greater. Somewhat similar results were obtained in the second study; with intact beaks, the selected line had significantly higher egg production, egg mass, and survival than its control. However, with ⅔ of the beak removed, differences in egg production, egg mass, and survival were no longer as evident Differences in production were presumably due to stress induced by birds with intact beaks. In comparisons between the selected and the commercially-derived stock, Craig and Muir (1991) found that egg production was at about the same level with all three levels of beak trimming. However, the selected stock had significantly better survival when beaks were left intact Craig and Muir (1991) hypothesized that kin selection favored cooperative or at least tolerant behavior as suggested by Crow and Kimura (1970) and concluded that selection on family means when families are reared as family groups provides a method of improving traits in which behavioral interactions influence overall well-being and productivity.

Muir (1996) reported that after six generations, in comparison to the unselected control, annual percent mortality of the selected line in multiple-bird cages decreased from 68% in the initial generation to 8.8% in the sixth generation. Percent mortality in the 6th generation of the selected line in multiple-bird cages was similar to that of the non-selected control in single-bird cages (9.1%). Annual days survival improved from 169 to 348 days and rate of lay improved from 52 to 68%. Annual egg mass improved from 5.1 to 14.4 kg per bird. The dramatic improvement in livability demonstrates that adaptability and well-being of these birds were improved by group selection. The similar survival of the selected line in multiple-bird cages and the control in single-bird cages suggests that beak-trimming of the selected line would not further reduce mortalities which implies that group selection can eliminate the need to beak-trim. An independent study by Craig and Muir (1993), involving different foundation stock, adds confirmatory evidence; kin-selection for days survival of intact-beak hens was dramatically increased relative to the unselected control over a two-generation study. In the Muir (1996) study, corresponding improvements in rate of lay and egg mass demonstrated that such changes can also be profitable.

Muir and Liggett (1995) compared the selected and control lines to a commercial line in generation 7. Birds were not beak-trimmed and lights during the laying period were set to high intensity. Birds which died were replaced with extra birds of the same line. In single-bird cages performance, as measured by eggs per hen housed, the commercial line was superior to that of the selected line but in 12-bird cages performances were reversed. The difference in ranking was due to both an improved rate of lay and viability. In the same study, Craig and Muir (1996) observed that feather scores did not differ in single bird cages among genetic stocks. However, in 12-bird cages, the selected line had significantly better feather score than the other lines.

The lines, described by Craig and Muir (1996), were subjected to the stress of housing at about 17 weeks, to cold stress at 36 weeks, and to heat stress at 47 weeks of age, with results as reported -by Hester et al. (1996a, 1996b). Blood physiology and egg production were monitored before, during, and after each of these periods. Packed cell volume immediately after housing indicated that the selected line adapted to the new watering system more quickly than the other lines. During cold stress the commercial and control lines showed an increase in heterophil to lymphocyte ratio in 12-bird cages while the selected line did not Egg production before, during, and after stress indicated that the selected line withstood social, handling, and environmental stress better than the control and in some case the commercial line. Similar observations with heat stress showed that the selected line withstood heat stress better as indicated by a lower mortality than the control or commercial lines. Egg production before, during and after heat stress indicated that the selected line withstood social, handling, and environmental stress better than the control line and in some cases the commercial.

B. Mixed Model Equations with One Random Effect (AM-BLUP).

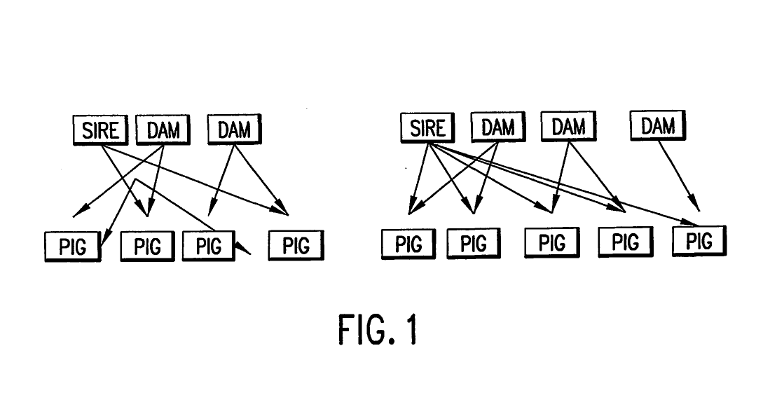

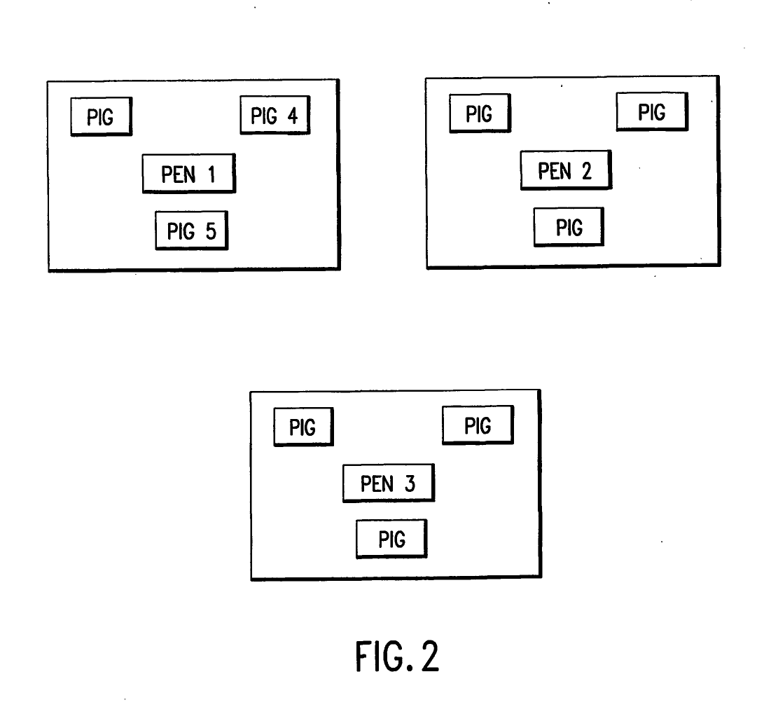

Consider the pedigree shown in FIG. 1. The pigs are randomly assigned to 3 pens as shown in FIG. 2. Assume all pigs are of the same sex and born approximately on the same day. Each pig is weighed at a standard number of days to give trait ‘Y’. The usual animal model to analyze this data is to ignore the effect of pen and use the following model:

Y=Xβ+Z_{d}μ_{d}+ε

TABLE 1
$[ \begin{matrix}{y}_{1} \\ {y}_{2} \\ {y}_{3} \\ {y}_{4} \\ {y}_{5} \\ {y}_{6} \\ {y}_{7} \\ {y}_{8} \\ {y}_{9}\end{matrix} ] = [ \begin{matrix}1 \\ 1 \\ 1 \\ 1 \\ 1 \\ 1 \\ 1 \\ 1 \\ 1\end{matrix} ] [ β ] + [ \begin{matrix}1 & 0 & 0 & 0 & 0 & 0 & 0 & 0 & 0 \\ 0 & 1 & 0 & 0 & 0 & 0 & 0 & 0 & 0 \\ 0 & 0 & 1 & 0 & 0 & 0 & 0 & 0 & 0 \\ 0 & 0 & 0 & 1 & 0 & 0 & 0 & 0 & 0 \\ 0 & 0 & 0 & 0 & 1 & 0 & 0 & 0 & 0 \\ 0 & 0 & 0 & 0 & 0 & 1 & 0 & 0 & 0 \\ 0 & 0 & 0 & 0 & 0 & 0 & 1 & 0 & 0 \\ 0 & 0 & 0 & 0 & 0 & 0 & 0 & 1 & 0 \\ 0 & 0 & 0 & 0 & 0 & 0 & 0 & 0 & 1\end{matrix} ] [ \begin{matrix}{μ}_{1} \\ {μ}_{2} \\ {μ}_{3} \\ {μ}_{4} \\ {μ}_{5} \\ {μ}_{6} \\ {μ}_{7} \\ {μ}_{8} \\ {μ}_{9}\end{matrix} ] + [ \begin{matrix}{ϵ}_{1} \\ {ϵ}_{2} \\ {ϵ}_{3} \\ {ϵ}_{4} \\ {ϵ}_{5} \\ {ϵ}_{6} \\ {ϵ}_{7} \\ {ϵ}_{8} \\ {ϵ}_{9}\end{matrix} ]$

Where:

Y is the vector of observation, β is a fixed effect due to the overall mean, μ_{d} is a vector of random effects associated with the direct genetic effect of each animal on growth and ε is a vector of random environmental effect The Mixed model equations to estimate the fixed and random effects is:

$$[ \begin{matrix}{X}^{′} X & {X}^{′} {Z}_{d} \\ {Z}_{d}^{′} X & {Z}_{d}^{′} {Z}_{d} + {A}^{- 1} \frac{{σ}_{ϵ}^{2}}{{σ}_{d}^{2}}\end{matrix} ] [ \begin{matrix}β \\ {μ}_{d}\end{matrix} ] = [ \begin{matrix}{X}^{′} Y \\ {Z}^{′} Y\end{matrix} ]$$

A is the inverse of the relationship matrix (Pedigree) among the animals, and

σ_{d}² σ_{ε}²

are the environmental and direct additive genetic variances respectively.

C. Extension of Current Theory: Extension of Model to Include Competitive Effects (CE-BLUP).

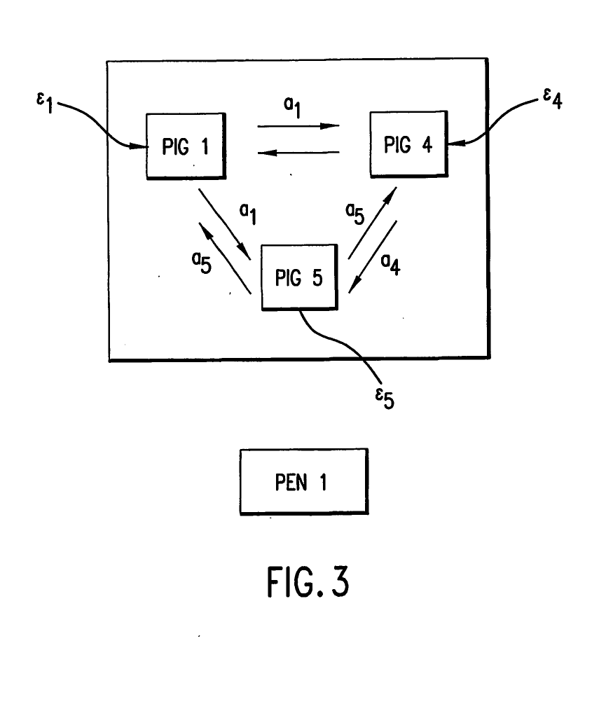

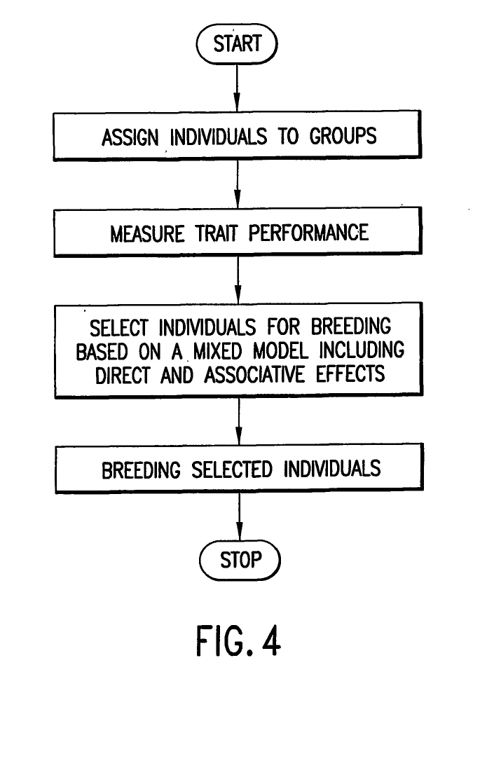

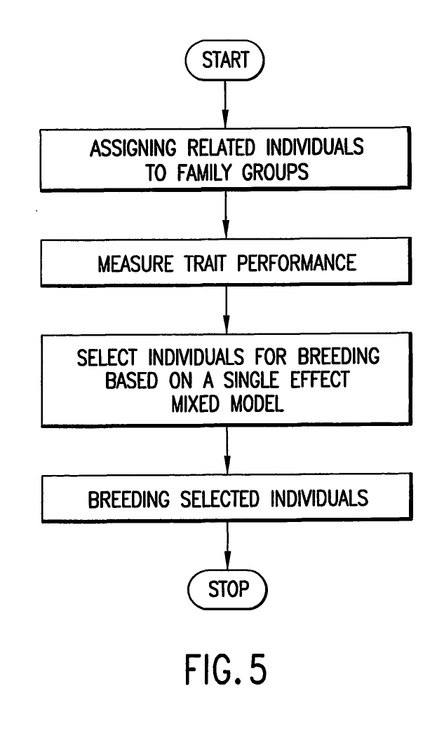

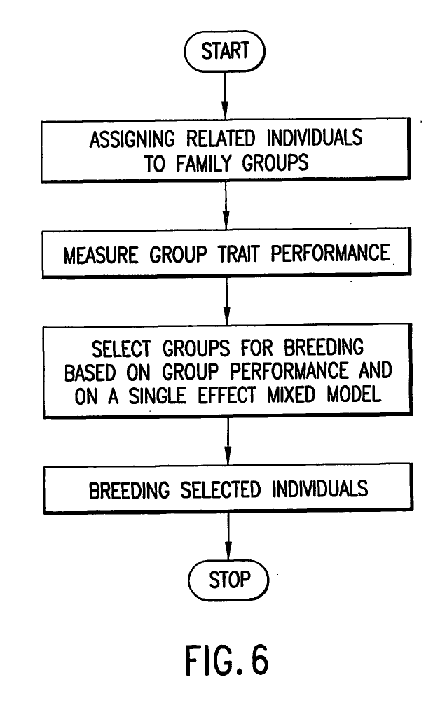

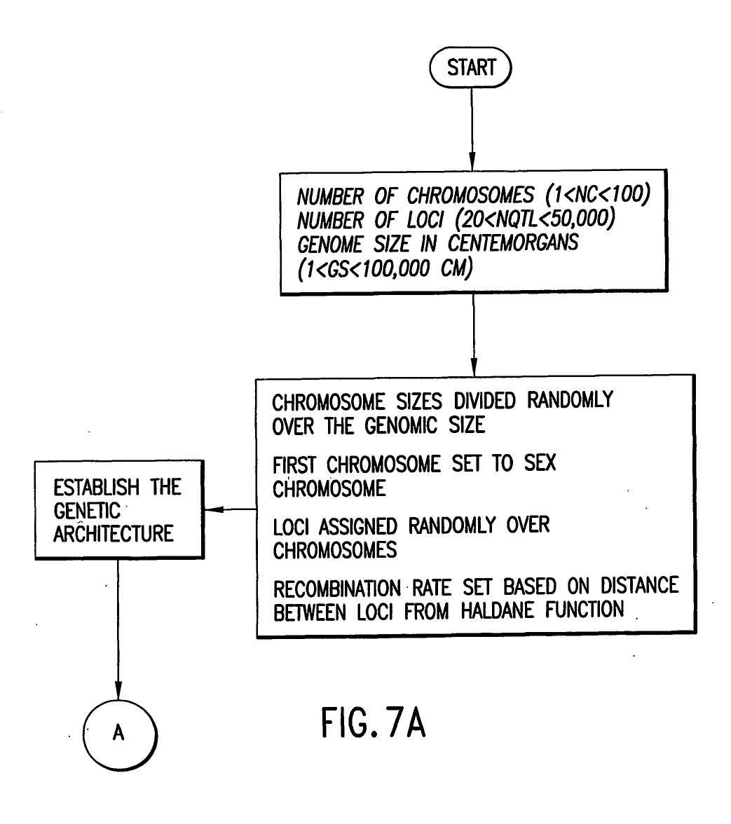

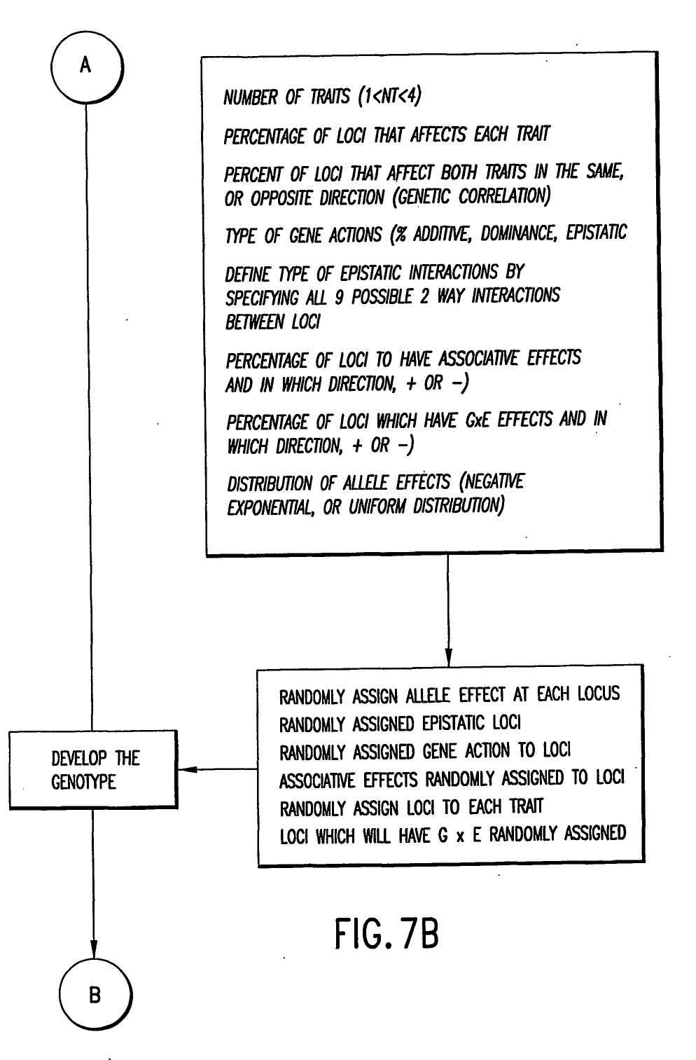

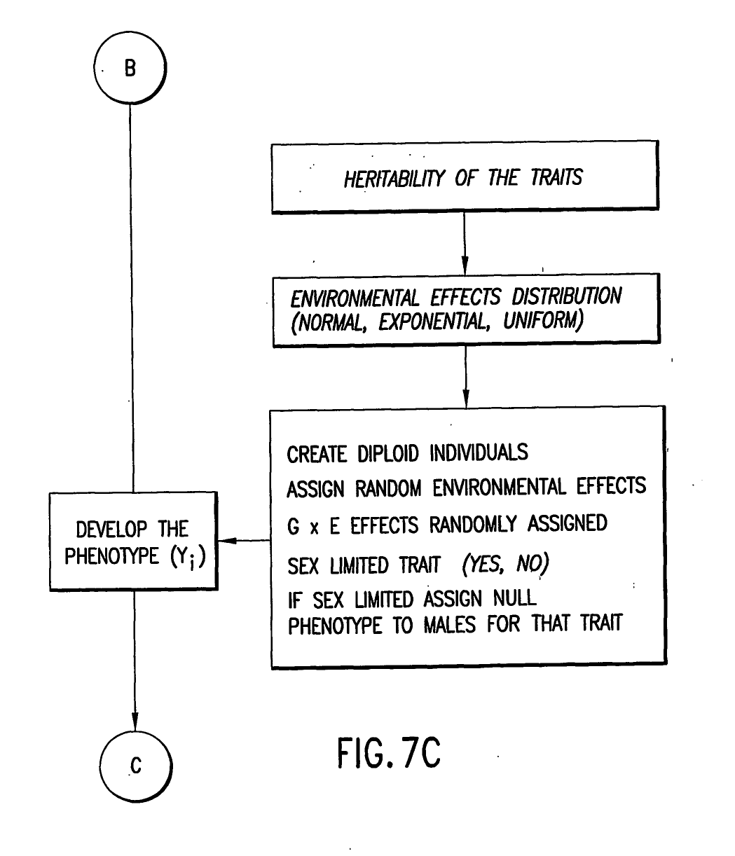

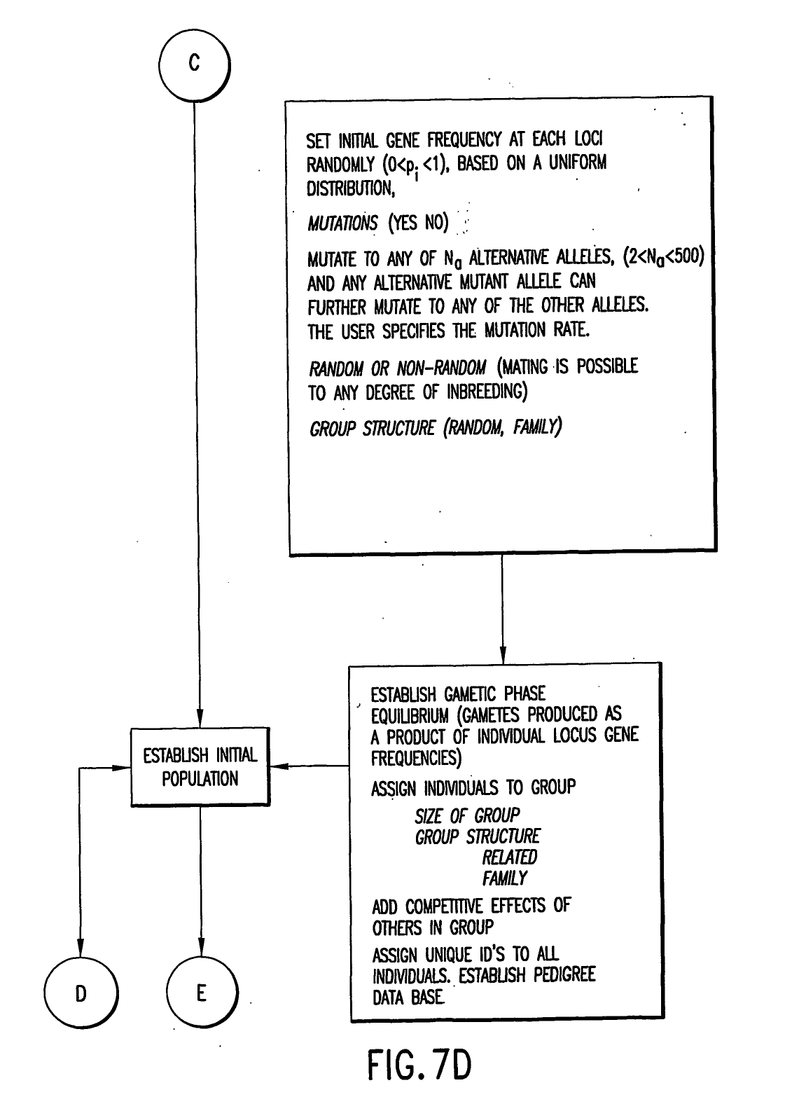

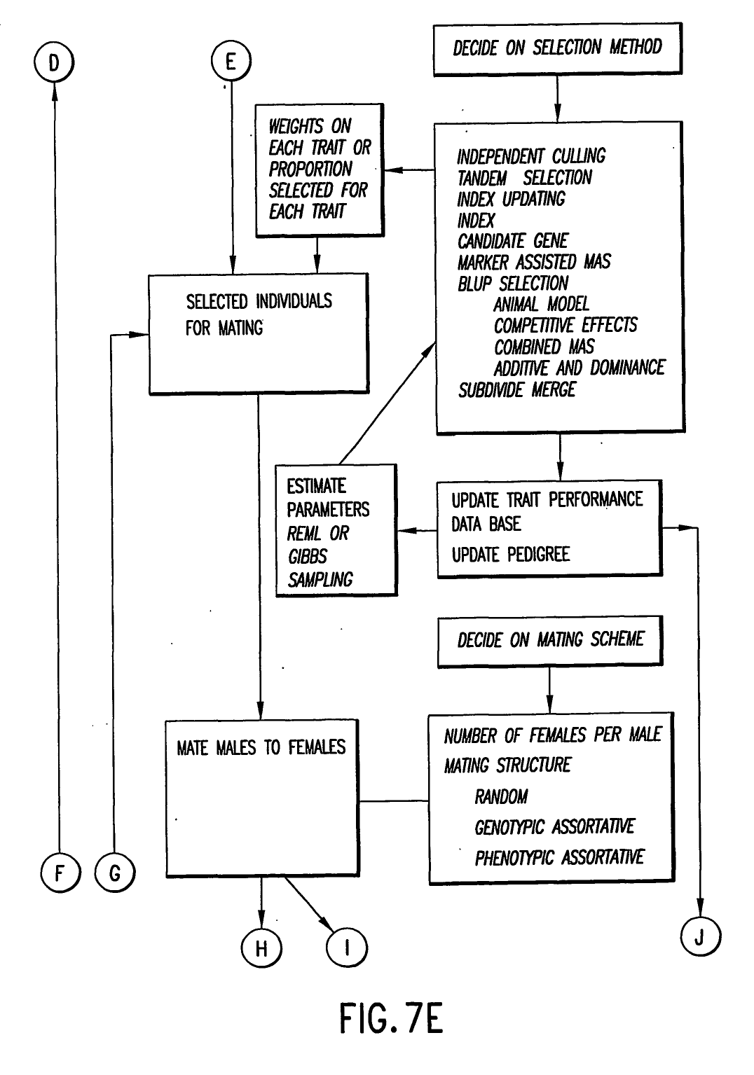

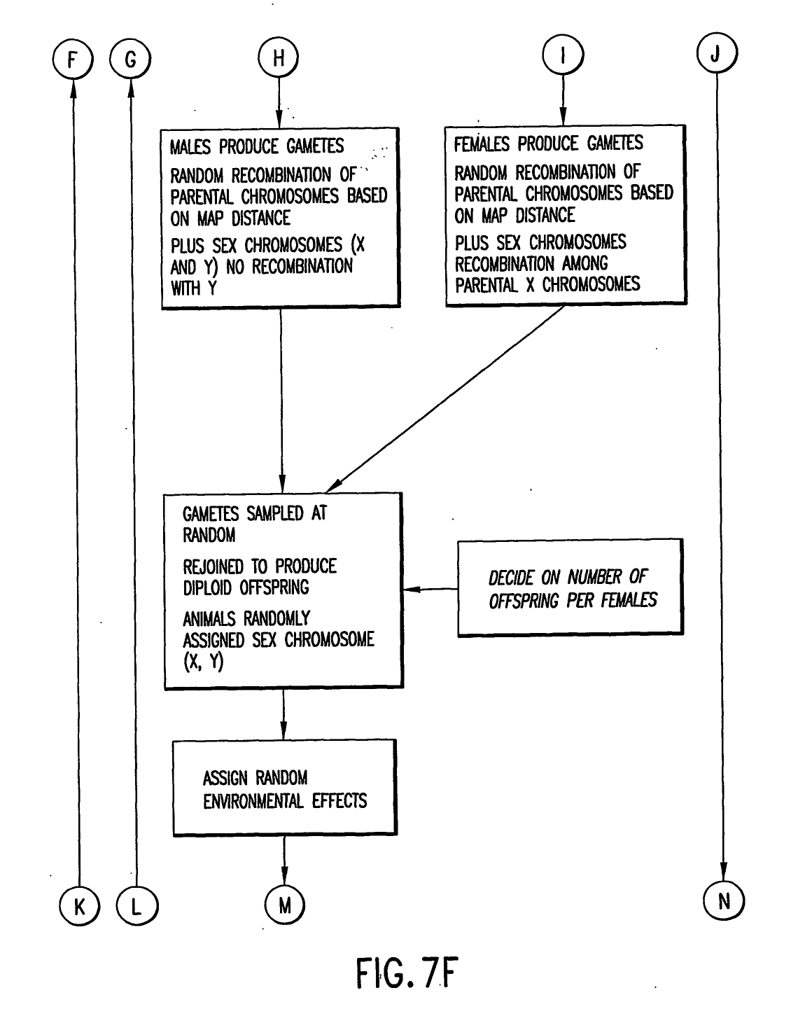

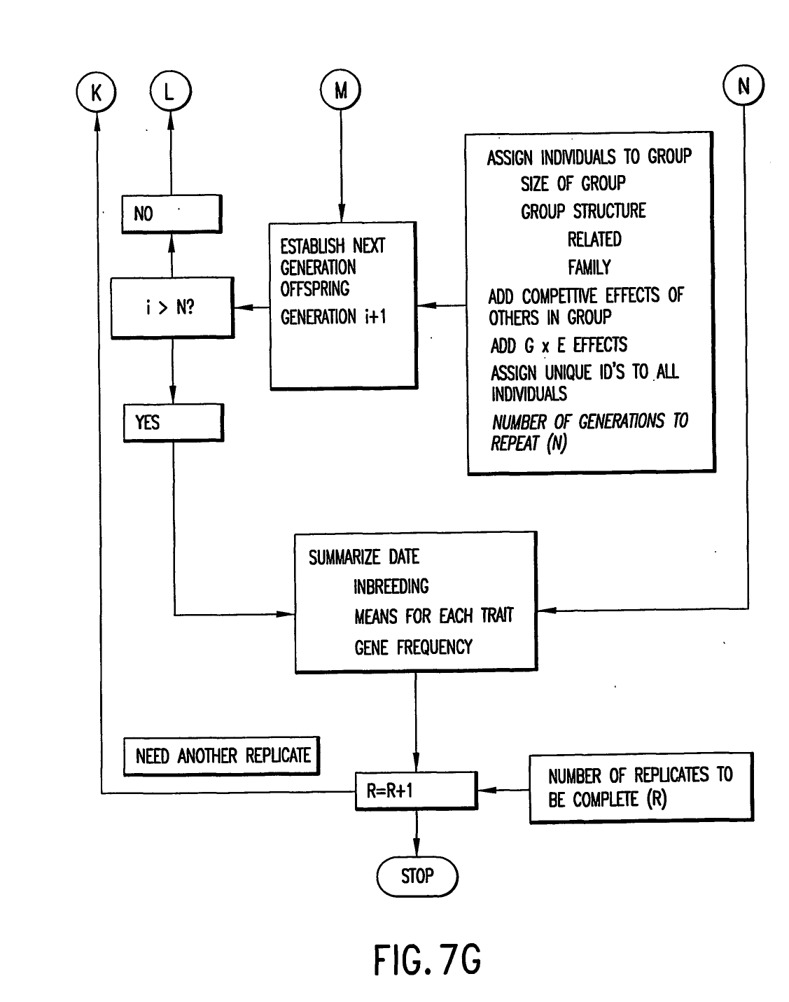

In the above example assume animals interact as shown in FIG. 3. The phenotype (Y) of each pig is influenced by its direct genetic effect (d), plus the associative effect (a) of other animals in the common group, plus random environmental effects (ε). For a particular pig, the associative effects of another pig is another environmental effect However, associative effects are inherited in the other pigs. The associative effects are thus an inherited environmental effect which only manifest themselves on others.

The mixed model is extended as follows

Y=Xβ+Z_{d}μ_{d}+Zₐμₐ+ε

Where

μₐ Zₐ

Are defined as associative genetic effects vector and coefficient matrix for associative effects.

For the above example

$${Z}_{a} = [ \begin{matrix}0 & 0 & 0 & 1 & 1 & 0 & 0 & 0 & 0 \\ 0 & 0 & 0 & 0 & 0 & 1 & 1 & 0 & 0 \\ 0 & 0 & 0 & 0 & 0 & 0 & 0 & 1 & 1 \\ 1 & 0 & 0 & 0 & 1 & 0 & 0 & 0 & 0 \\ 1 & 0 & 0 & 1 & 0 & 0 & 0 & 0 & 0 \\ 0 & 1 & 0 & 0 & 0 & 0 & 1 & 0 & 0 \\ 0 & 1 & 0 & 0 & 0 & 1 & 0 & 0 & 0 \\ 0 & 0 & 1 & 0 & 0 & 0 & 0 & 0 & 1 \\ 0 & 0 & 1 & 0 & 0 & 0 & 0 & 1 & 0\end{matrix} ] \\ [ \begin{matrix}{X}^{′} X & {X}^{′} {Z}_{d} & {X}^{′} {Z}_{a} \\ {Z}_{d} {X}^{′} & {Z}_{d}^{′} {Z}_{d} + {k}_{1} {A}^{- 1} & {Z}_{d}^{′} {Z}_{a} + {k}_{2} {A}^{- 1} \\ {Z}_{a} {X}^{′} & {Z}_{a}^{′} {Z}_{d} + {k}_{2} {A}^{- 1} & {Z}_{a}^{′} {Z}_{a} + {k}_{3} {A}^{- 1}\end{matrix} ] [ \begin{matrix}β \\ {μ}_{d} \\ {μ}_{a}\end{matrix} ] = [ \begin{matrix}{X}^{′} X \\ {X}^{′} {Z}_{d} \\ {X}^{′} {Z}_{a}\end{matrix} ]$$

The mixed model equations to estimate direct and associative effects are

$$[ \begin{matrix}{k}_{1} & {k}_{2} \\ {k}_{2} & {k}_{3}\end{matrix} ] = {{σ}_{ϵ}^{2} [ \begin{matrix}{σ}_{d}^{2} & {σ}_{ad} \\ {σ}_{ad} & {σ}_{a}^{2}\end{matrix} ]}^{- 1} Where$$

σ_{d}²

is the variance of additive direct effect and

σₐ²

is the variance of additive associative effect

σ_{ad}

is the additive genetic covariance between direct and associative effects

D. Index Weights.

Define an index (Iᵢ) for the i^{th} individual as

Iᵢ=âᵢ=bᵢX₁+b₂X₂

Were âᵢ is the predicted breeding value (b₁, b₂) are index weights and (X₁, X₂) are the estimated direct and associative effects. The weights can be arbitrary, or set to bring about desired gains, or optimal to increase group performance at the maximum rate. Optimal weights on the direct and associative effects can be found by classic selection index theory (Cameron, 1997; Mrode, 1996)) as follows: Assume direct and associative effects have been estimated for a set of parents, and offspring performance for a given trait (Yᵢ) has been observed in group setting with known structure. The object is to find (b₁, b₂) such that the correlation between the true breeding value (aᵢ) and the predicted breeding value (â₁) is maximum. The correlation has often been called the accuracy of prediction (Mrode, 1996). This objective is accomplished solving the following set of equations:

$$[ \begin{matrix}{p}_{11} & {p}_{12} \\ {p}_{11} & {p}_{22}\end{matrix} ] [ \begin{matrix}{b}_{1} \\ {b}_{2}\end{matrix} ] = [ \begin{matrix}{g}_{11} \\ {g}_{12}\end{matrix} ] or Pb = G$$

Where P is the variance-covariance matrix of direct and associative effects of the parents and G is the genetic covariance between the offspring performance and the parental direct and associative effects. The weights (b) are found as:

b=P⁻¹G

E. Estimation of Genetic Parameters for CE-BLUP.

Use of mixed model equations to find BLUP breeding values for both direct and associative effect effects requires estimation of the genetic variance-covariance matrix for direct and associative effects.

Restricted likelihood estimation of genetic parameters. Direct maximization of the likelihood function using derivative free methods (DF-REML) finds estimates which directly maximizes the likelihood and as such does not require a full inverse, but computation of the likelihood requires the mixed model equations to be reduced to its triangular form.

For the GS model

Y=Xβ+Z_{D}μ_{D}+Z_{A}μ_{A}+ε

with M base animals (animals without records) and N animals with observations, the log of the likelihood of observing the data given the parameters can be written as

L=−0.5ln|R|−0.5ln|G|−0.5ln|C|−0.5Y′PY

The individual terms are found as following

The first term is

$$\begin{matrix}ln \vert R \vert = ln \vert I {σ}_{e}^{2} \vert \\ = {ln ( {σ}_{e}^{2} )}^{N} + ln \vert I \vert \\ = N ln ( {σ}_{e}^{2} )\end{matrix}$$

The second term is defined as

$$G = [ \begin{matrix}A {σ}_{D}^{2} & A {σ}_{AD} \\ A {σ}_{AD} & A {σ}_{A}^{2}\end{matrix} ]$$

where A is the additive relationship matrix.

The matrix can be written as

$$\begin{matrix}G = [ \begin{matrix}H & B \\ Q & D\end{matrix} ] \\ \vert G \vert = \vert H \vert \vert D - {QH}^{- 1} B \vert\end{matrix}$$

$$OR$$

$$\vert G \vert = \vert D \vert \vert H - {BD}^{- 1} Q \vert$$

$$Therefore$$

$$\begin{matrix}\vert G \vert = \vert A {σ}_{D}^{2} \vert \vert A {σ}_{A}^{2} - A {{σ}_{AD} ( A {σ}_{D}^{2} )}^{- 1} A {σ}_{AD} \vert \\ \vert G \vert = \vert A {σ}_{D}^{2} \vert \vert A ( {σ}_{A}^{2} - {σ}_{AD}^{2} / {σ}_{D}^{2} ) \vert \\ \vert G \vert = \vert A \vert {( {σ}_{D}^{2} )}^{M + N} \vert A \vert {( {σ}_{A}^{2} - {σ}_{AD}^{2} / {σ}_{D}^{2} )}^{M + N}\end{matrix}$$

$$\begin{matrix}ln \vert G \vert = ( M + N ) ln ( {σ}_{D}^{2} ) + ( M + N ) ln ( {σ}_{A}^{2} - {σ}_{AD}^{2} / {σ}_{D}^{2} ) + 2 ln \vert A \vert \\ ln \vert G \vert = ( M + N ) [ ln ( {σ}_{D}^{2} ) + ln ( {σ}_{A}^{2} - {σ}_{AD}^{2} / {σ}_{D}^{2} ) ] + 2 ln \vert A \vert\end{matrix}$$

$$and$$

$$ln \vert A \vert$$

is a constant

The third term is defined as

$$\begin{matrix}C = [ \begin{matrix}{X}^{′} X & {X}^{′} Z \\ {Z}^{′} X & {Z}^{′} Z + {G}^{- 1} {σ}_{e}^{2}\end{matrix} ] \\ ln \vert C \vert = {\sum }_{i = 1}^{M + N + R} ln {λ}_{i}\end{matrix}$$

Where λᵢ=is the ith diagonal element of the triangular reduction of C.

Finally, Y′PY the last term is the residual mean square found as

Y′PY=Y′(Y−Xβ−Zμ)

Starting with an initial value of the genetic parameters, the maximum value of L, or equivalently the log of L is found using a simplex search, or alternatively by EM-REML. Similar estimates can be arrived at by Gibbs sampling or other methods of estimating variance components known in the art.

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various usages and conditions.

### Example 1

Projected Impact on Breeding Programs: Computer Simulation Program

A finite-locus simulation program was developed. Genetic simulation programs written previously are based on the infinitesimal model. The infinitesimal model requires the assumption of an infinite number of loci such that selection never changes gene frequency. Further, effects of selection on genetic variance assumes a strictly additive model. Because those assumptions are known to be violated in nature, this program as developed such that a more realistic simulation would result and to examine effects of changing gene frequencies, higher order gene action, and competitive effects on selection response and optimal selection procedures.

The simulation starts by developing a genetic architecture. In nature the genetic architecture is that which makes each species unique, i.e. the number of chromosomes, loci genome size, etc. In the simulation, specifying the number of chromosomes and the genomic size in centemorgans sets the architecture. Chromosome lengths can either be specified or assigned from a negative exponential distribution. The number of QTL's is specified by the user (20<NQTL<50,000) and is randomly assigned to a physical position in the genome based on a uniform distribution over the genome. The first chromosome assigned is defined as the sex chromosome.

Each locus is assigned to a trait or traits that the locus influences. The program only allows for three quantitative traits, all three of which must exist and be defined; the user specifies the percentage of loci that affects each trait The number of loci that affect both traits in the same, or opposite direction determines the direction and magnitude of the genetic covariance between traits; the user specifies that proportion. The type of gene action that each locus will have (additive, dominance, and epistatic), is randomly assigned based on percentage of loci with each type of gene action, as specified by the user. Epistatic loci are assigned pairwise, but the position of each matching pair is random over the genome, i.e. epistatic loci do not necessarily exist in clusters nor are adjacent to each other. With competition, each trait is defined to have both a direct and an associative effect The direct effect influences the performance of the animal and the associative effect influences the performance of other animals. Each locus is assigned as to whether or not it will have an associative effect (+, 0, or −) based on the percentage of loci desired by the user to have associative effects and in which direction. This setting will determine the magnitude and direction of the covariance between direct and associative effects. If genotype x environment interactions (GxE) are desired, each locus is also assigned as to whether or not it will have a GxE effect (+, 0, or −) based on the percentage of loci desired by the user to have GxE effects and in which direction. Thus, it is possible for a locus to have pleiotropic effects, any type of gene action, associative effects, and expression dependent on the environment.

Two alleles are assigned to each locus, the value of each allele is randomly determined based on either a normal, negative exponential, or uniform distribution, as specified by the user. Regardless of the distribution chosen, the scale is such that the distribution of allele effects has a mean of zero and unit variance. Initially the frequency of each allele is randomly set to a value (0<pᵢ<1), based on a uniform distribution, and different for each locus. For a model in which mutations are desired, a finite alleles mutation model is assumed in which the population initially starts with two alleles and can mutate to any of Nₐ alternative alleles, (2<Nₐ<500) and any alternative mutant allele can further mutate to any of the other alleles. The user specifies the mutation rate.

The initial population was established based on the assumption of gametic phase equilibrium, i.e., gametes were produced as a product of individual locus gene frequencies. Zygotes are produced based on the assumption of random mating; i.e. gametes are combined at random. Non-random mating is possible to any degree of inbreeding, F, based on the conditional probability of the second allele being identical by descent with the fist allele given the state of the first allele, i.e. sample only one gamete and chose the second allele based on F and pᵢ. Sex of the zygote is alternated for each individual produced. If the individual is a male, corresponding alleles on the Y chromosome are set to null, i.e. no value.

The phenotype of each individual is determined based on the genotypic and environmental effects. The genotypic effect is determined based on the alleles at each locus and which trait(s) they influence. If the locus is additive, effects of both alleles are summed to give the locus effect If the locus is dominant, directional dominance is assumed, i.e. if one of the dominant alleles is present, twice the larger allele effect is assigned as the locus effect; otherwise the smaller allele effect is assigned. If the locus is epistatic to another, the combination of alleles present at both loci determines the scale effect to be used for those loci. The epistatic scale effects table is input by the user. Any combination of epistatic interactions is possible. With two alleles at a locus, nine possible genotypic combinations exist The combination of alleles present at both loci determines which of the nine combinations to use as the scale effect for that pair of loci. The scale effect is multiplied by the largest allele effect assigned at both loci and becomes the locus effect.

The genetic values of the traits are now determined as the sum of the loci effects. If a locus is pleiotropic, the locus effect is added or subtracted to each trait depending on the direction the locus affects each trait as specified on input These effects contribute to the direct genetic variance. If competitive effects are specified, associative effects are determined for each trait. The associative effects of an animal do not contribute to the phenotype of the trait of that animal, but rather to phenotypes of animals in the same group. Thus, the associative effect of other animal's effects the performance (phenotype) as if it is an environmental effect The environmental effect for an animal includes the associative effects of all other animals in the group. For those loci which were assigned associative effects, the locus effect times a scale parameter will be added or subtracted from the trait associative value depending on the direction assigned to the locus. The scale parameter is specified on input and determines the magnitude of the associative genetic variance. The proportion of loci that have positive or negative effects determines the magnitude and sign of the covariance between direct and associative effects.

The genetic variances and covariances are now computed. These values are used to determine the degree of environmental effects needed to produce the desired heritabilites, which were specified on input Environmental effects can be sampled from a normal, exponential, uniform, gamma, or Poisson distribution. An environmental correlation matrix among the three traits is specified on input The correlation matrix is transformed into a matrix of scale effects based on the genetic variance covariance matrix to obtain traits with the desired heritabilites. A vector of random deviates sampled from one or more of the above distributions is multiplied by the Cholesky decomposition of the scale effect matrix. The result is a vector of random deviates with the desired variance covariance structure. The vector of random deviates is added to the vector of genotypic trait values to produce the phenotype. The resulting phenotype that will have heritabilites as specified on input and environmental correlations among traits as specified on input.

If GxE effects were specified, if a locus contributes to a GxE, the genetic effect of that locus is multiplied by the environmental effect sampled for that individual times a scale effect The result is added or subtracted from the phenotype depending on the direction the locus affects the trait The scale effect was specified on input and determines the degree to which GxE affect the trait The percentage of loci that have positive vs. negative effects determines the direction of the GxE.

Animals are now assigned to groups. A group is a set of animals that are reared together in a common area such as a pen or cage. A group can be composed of random, full-sib, or half-sib individuals. Within each group associative effects of other animals in the same group are added to the trait values of other animals in the group. A critical assumption is made here that needs to be verified. It is assumed that an individual's associative effect influences all other animals in its group similarly regardless of the size of the group. The alternative is to assume that an animal's associative effect on other animals reduces proportionately to the size of the group. With constant group sizes, this assumption has the same effect as changing the scale effect. The phenotype along with sire, dam, and animal identification numbers are output to a data set either as the individual's performance or the mean of the group for all individuals in the group. The former value is used when selection is based on individual performance; the latter is used for pure group selection, where the group as a whole is selected.

Either external or internal selection programs can be used to choose which individuals are culled. Internal programs include procedures for parameter estimates (EMREML and DFREML) and estimates of breeding values based on AM-BLUP. Two BLUP models were implemented: a CE BLUP mixed model, that includes both direct and associative genetic effects, and an AM BLUP mixed model, which only includes direct effects. Animals can be selected by a wide range of procedures including random index (multi-trait), tandem, independent culling, index updating, and procedures for incorporating molecular information including marker assisted and candidate genes. With competition effects, selection can be for any combination of direct and associative effects or based on the group for any combination of traits. The selected proportion can be the same or different among the sexes. Sex limited traits are currently under development.

Selected males and females are randomly mated. Alternative methods of mating such as phenotypic assortative and inbreeding avoidance procedures are under development Gametes are produced by selected males and females based on pairwise recombination of chromosomes and assumes no interference. Recombination between loci is based on Haldane's formula for map distance between loci. This formula sets the probability of recombination between adjacent loci and asymptotically approaches a value of 0.5. Loci on different chromosomes have a recombination probability of 0.5. If the mutation rate is set greater than zero, new alleles are created in proportion to the set mutation rate. Gametes produced by a mating pair are combined to produce offspring. The sex of offspring is alternated with an equal number of males and females always produced. Provision for unequal sex ratio is under development. Recombination occurs among the sex chromosomes of the female parent but not the male parent.

The procedure starts over again to produce the next generation. Any number of total generations is possible. After the specified number of generations has been produced, the procedure can be started over again with the same initial gene frequencies for any number of replicates. In this way, effects of drift can be examined. At the termination of all replicates, summary programs estimate generation means, realized heritabilites, and heritabilites estimated from parent-offspring regression, and degree of inbreeding based on a number of different procedures, including theoretical and molecular information.

Extensive verification/testing of the program was completed as each subroutine was written. Testing included comparison with known theory for 1) response to selection, 2) correlated response to selection, 3) effect of method of selection on response to selection (BLUP, vs., mass, and multi-trait index vs. tandem and independent culling), 4) selection limits as related to selection intensity and population size, 5) rate of inbreeding as influenced by population size and selection intensity, 6) random genetic drift, and 7) group performance as influenced by associative effects and selection method (individual vs. group).

The optimum method to incorporate GS was investigated. There are at least three ways to incorporate associative effects: 1) Pure Group selection in which animals are housed in family groups and selected as a group. This methods has shown to be effective in poultry but has the downside of rapidly increasing the rate of inbreeding. Further permanent environmental effects are confounded with the group. 2) Individual selection in family groups using AM BLUP incorporating only direct effects and, 3) Individual selection in random groups using CE BLUP incorporating two random effects that of the direct and associative effects. The latter two methods overcome the inbreeding problem associated with GS. However, it is not know which of the latter methods are most beneficial and are which combinations of genetic parameters.

Four simulations were devised to answer those questions. Conditions: 256 Animals/generation; 16 males and 32 females selected per generation, Group size=8; Two group structures were examined: Pens composed of 1) Full sibs, 2) Random; Two BLUP models were examined, 1) CE which includes direct and associative effects and 2) AM which only includes Direct effects; Two weighting structures were examined with CE-BLUP, 1) Optimal weighting and 2) Associative effects only; Two sets of genetic parameters were examined, that with strong associate effects, and with weak associative effects. These were not examined in a factorial manner but rather limited to those cases which were of interest Those are as follows and detailed in the following table

CASE 1 uses a CE-BLUP model with direct and associative effects in the model but only selects on the associative effects

CASE 2 uses an AM-BLUP model with only direct effects in the model but groups are full sibs (FGAM-BLUP)

CASE 3 uses a CE-BLUP model with optimal weighting of the direct and associative effects

CASE 4 uses an AM-BLUP model with only direct effects in the model and the group is made up of random individuals. This method is the current state of the art.

Each simulation was replicated 10 times, starting over with different gene frequencies and genetic structure, i.e. location of QTLs on the chromosomes, and gene affects.

Optimal weights for direct and associative effects B=(b₁, b₂) were found by finding the parental variances and covariances for direct and associative effects (P), their covariances with the offspring performance (G) and solving

B=P⁻¹G.

For each replicate, selection was continued for 4 generations and response regressed on generations. The regression coefficient for each replicate and treatment combination was analyzed in analysis of variance with intensity of competitive effects (COMP) and selection methods (CASE) as main effects.

TABLE 2

| | | GROUP | WEIGHTS | |
|---|---|---|---|---|
| CASE | MODEL | STRUCTURE | DIRECT | ASSOCIATE |
| 1 | CE | RANDOM | 0 | 1 |
| 2 | AM | FULL SIB | 1 | 0 |
| 3 | CE | RANDOM | b₁ | b₂ |
| 4 | AM | RANDOM | 1 | 0 |

1. Strong Competitive Effects:

Genetic parameters:

$$\begin{matrix}{σ}_{D}^{2} = 59 & {h}_{D}^{2} = .50 \\ {σ}_{A}^{2} = 33 & {h}_{A}^{2} = .35 \\ {σ}_{DA} = - 27 & {r}_{AD} = - .6 \\ {σ}_{E}^{2} = 59 & \\ ( {b}_{1} = .62 , {b}_{2} = 2 ) & \end{matrix}$$

2. Weak Competitive Effects:

Genetic Parameters

$$\begin{matrix}{σ}_{D}^{2} = 75 & {h}_{D}^{2} = .5 \\ {σ}_{A}^{2} = 3 & {h}_{A}^{2} = .045 \\ {σ}_{DA} = - 9.5 & {r}_{AD} = - .6 \\ {σ}_{E}^{2} = 75 & \\ ( {b}_{1} = .726 , {b}_{2} = 5.35 ) & \end{matrix}$$

TABLE 3
ANOV of response to selection

| Source | DF | SS | Mean Square | F Value | Pr > F |
|---|---|---|---|---|---|
| COMP | 1 | 5955.2145 | 5955.2145 | 512.72 | 0.0001 |
| CASE | 3 | 9311.6731 | 3103.8910 | 267.23 | 0.0001 |
| COMP*CASE | 3 | 7441.4236 | 2480.4745 | 213.56 | 0.0001 |
| Error | 72 | 836.279 | 11.615 | | |

TABLE 4
Mean response to selection by competitive effects and case.

Competition

| CASE | Strong | Weak |
|---|---|---|
| 1 | 37.75 ± 1.04 | 2.38 ± 0.29 |
| 2 | 20.48 ± 2.01 | 5.31 ± 0.47 |
| 3 | 36.70 ± 1.22 | 4.80 ± 0.26 |
| 4 | −12.68 ± 1.44 | 0.73 ± 0.41 |

The strong significant interaction between selection method and intensity of competitive effects indicates that the optimal method of selection is dependent on the degree of competitive effects. With strong competitive effects, CE BLUP in random groups was optimal, using either optimal weighting or selection only for associative effects.

With weak associative effects, the optimal selection program resulted from assigning animals to pens by family groups and using a FGAM-BLUP. The most likely explanation for these results is in how precisely the direct and associative effects can be estimated for each animal. With strong competitive effects, associative effects are easy to estimate. With weak competitive effects, associative effects are difficult to estimate precisely and as a result numerous errors in selection decisions are made. In contrast, when selecting in full-sib groups ignoring the associative effects the procedure is self correcting because all members in the group contribute to the same genetic associative effect That is, in a full sib group the families associative effects are reflected in the group mean. In a random groups, the average associative effect on the group mean is zero. Therefore in family groups the group mean is the best estimate of the individuals associative effects and selection on the combination of the family mean and individual performance automatically includes a combination of the direct and associative effects. FGAM-BLUP includes exactly those two components.

With weak associative effects, optimal weighting of the direct and associative effects was significantly better than selecting only for associative effects and was not significantly worse than FGAM-BLUP.

These results also show that in the presence of competition, strong or weak, either of the three methods were better than AM-BLUP. Because AM-BLUP in random groups has produced positive improvement in some selection programs in the past, one can conclude that weak competitive effects are present in those programs. Nevertheless, CE-BLUP with optimal weighting in random groups produced 7 times the gain as AM-BLUP in random groups, and selection using FGAM-BLUP produced 8 times the gain. In breeding operations, one should either use FGAM-BLUP or CE-BLUP, whichever is easier to implement.

Unique aspects of the simulation program used to examine alternative breeding method and included in the present invention include:

1. The genetic architecture can be completely specified.

2. All aspects of architecture are randomized to avoid bias or hidden assumptions.

3. Loci are randomly distributed over genome.

4. Allele effects are random at each locus.

a. Normal, exponential, and uniform distribution of allele effects can be specified.

b. Any number of alleles at a locus can be specified (limited by memory of the computer used).

c. Mutations allowed with any mutation rate.

d. Marker alleles are neutral, the number of which can be specified for MAS.

5. Gene frequencies are different and random of each loci.

6. Populations can be initialized with any level of inbreeding.

7. Any population structure may be used.

8. Population size is only limited only by memory of the computer used.

9. Any type of gene action(s).

10. Completely specify any type of 2 locus epistasis.

11. Multi trait (up to 3).

12. Any degree of pleiotropic effect of genes among traits possible.

a. Any genetic correlation among traits possible.

13. Environmental effects.

a. Heritability specified.

b. Environmental effect can be correlated to any degree among traits.

c. Environmental effects can interact with the genotype in a non-linear way (G x E).

d. Normal, exponential and uniform distribution of environmental effects possible.

14. Competitive effects included in model.

a Competitive effects are inherited.

b. Can be pleiotropic among traits.

c. Can have positive and negative effects to any degree.

d. Can specific additive direct, additive associative, and covariance among direct and associative effects.

e. Any degree of genetic competitive effects can be specified from strong to weak with any correlation structure.

15. Any group structure possible (random, related, segregated by sex, any size).

16. Any type of genetic selection program can be implemented, single or multi-trait.

a. Independent culling.

b. Tandem selection.

c. Index.

d. Multi-stage index.

e. Subdivide-merge.

f. Marker Assisted.

g. Candidate Gene.

h. BLUP.

i. One random effect (direct).

ii. Two random effects.

1. (direct and associate).

2. (additive and dominance)

iii. Parameter estimation from the data.

1. REML

2. Gibbs sampling

17. Calculates inbreeding.

a. Based on pedigree.

b. Based on within population variance.

### Example 2

Sensitivity Analysis of Estimates of Genetic Effects to Parameter Estimates Comparison of Selection Response with Biased Parameters

In order to determine if the various methods are sensitive to parameter estimates, it is necessary to examine the effect of variation in parameter estimates on expected response to selection.

The method used for sensitivity analysis was to compare response to selection, using CE-BLUP, FGAM-BLUP, or AM-BLUP, using true genetic parameters and parameters which deviate from true by plus and minus 50%, in all combinations of the three parameters (direct σ^{w}_{D}, associativeσ²_{A}, and the covariance between direct and associative σ_{DA}). In addition, two possible situations were examined, weak competition, and strong competition. To examine the sensitivity of weights for direct and associative effects, three combinations of weights were examined: Selection only on the direct effect, selection only on the associative effects, and optimal weights. In each case the population size was 256, groups size was 16, and 16 males and 32 females selected per generation for 5 generations. Each female was assumed to produce 8 offspring and half sib families consisted of one male mated to two females for a total of 16 half sibs. Each combination was replicated 10 times. These are categorized as outlined in Table 5.

TABLE 5

| | BLUP | GROUP | WEIGHTS | |
|---|---|---|---|---|
| CASE | MODEL | ORGANIZATION | DIRECT | ASSOCIATE |
| 1 | CE | RANDOM | 0 | 1 |
| 2 | CE | RANDOM | 1 | 1 |
| 3 | AM | Half SIBs | 1 | 0 |
| 4 | CE | RANDOM | Optimal | Optimal |
| 5 | AM | RANDOM | 1 | 0 |

CASE 1 is CE-BLUP but only selects on the associative effects

CASE 2 is CE-BLUP but only selects on the direct effects

CASE 3 is FGAM-BLUP

CASE 4 is CE-BLUP with optimal weighting of the direct and associative effects

CASE 5 is AM-BLUP

Strong and weak competition were defined in terms of the genetic parameters of Table 6.

TABLE 6

| Competition | σ²_{D} | σ²_{A} | σ_{DA} | σ²_{E} | h²_{D} | r_{AD} | h²_{A} |
|---|---|---|---|---|---|---|---|
| Strong | 81 | 5.9 | −11.8 | 81 | .5 | −.6 | .034 |
| Weak | 76 | 0.84 | −4.48 | 76 | .5 | −.6 | .0055 |

Response to selection with different selection methods was computed as the regression of mean response on generation number for each replicate and combination of parameters. To determine the effect of parameter estimates on response, the means, variance, and rankings of the regression coefficients were compared.

Table 7 gives consistency of ranking for each combination of variables. Table 8 gives mean response and variation in response with a range of parameters used for selection in each case. For strong associative effects the methods sort out the same regardless of parameter estimates. Case 4 is the optimal (CE-3LUP selection with optimal weighting) in nearly all cases or a close second to Case 1 (CE-BLUP selection with selection only for associative effects). With weak associative effects Case 3 is uniformly best (AM BLUP selection in half-sib family groups). The next best case was determined from the following summary table averaging over parameter estimates. While Case 1 is slightly superior to case 4, the variation of response with Case 4 is half that of Case 1. Both cases give approximately 30% more response to selection than Case 5 (FGAM BLUP).

TABLE 7

| | | | | | Response | |
|---|---|---|---|---|---|---|
| | | | | | Per | |
| Competition | CASE | SIGD | SIGAD | SIGA | Generation | STD Error |
| Strong (S) | | | | | | |
| S | 2 | 121.5 | −17.7 | 2.95 | −20.4519 | 0.67829 |
| S | 2 | 40.5 | −17.7 | 8.85 | −19.7737 | 0.82054 |
| S | 2 | 121.5 | −17.7 | 5.9 | −19.6894 | 1.00819 |
| S | 2 | 81 | −11.8 | 2.95 | −19.4362 | 1.24268 |
| S | 2 | 40.5 | −11.8 | 5.9 | −19.433 | 1.3377 |
| S | 2 | 81 | −17.7 | 5.9 | −19.2698 | 1.61572 |
| S | 2 | 81 | −11.8 | 5.9 | −18.9883 | 1.30072 |
| S | 2 | 81 | −17.7 | 8.85 | −18.487 | 1.60094 |
| S | 2 | 121.5 | −5.9 | 5.9 | −18.3735 | 1.273 |
| S | 2 | 40.5 | −11.8 | 8.85 | −18.32 | 1.27528 |
| S | 2 | 121.5 | −5.9 | 8.85 | −18.2508 | 1.02817 |
| S | 2 | 121.5 | −11.8 | 5.9 | −17.9093 | 1.28863 |
| S | 2 | 121.5 | −17.7 | 8.85 | −17.5007 | 1.07901 |
| S | 2 | 121.5 | −11.8 | 2.95 | −17.3501 | 1.16709 |
| S | 2 | 40.5 | −5.9 | 8.85 | −17.2985 | 1.02717 |
| S | 2 | 81 | −11.8 | 8.85 | −16.8403 | 1.46851 |
| S | 2 | 81 | −5.9 | 8.85 | −16.5242 | 1.12764 |
| S | 2 | 121.5 | −5.9 | 2.95 | −16.1556 | 1.01258 |
| S | 2 | 81 | −5.9 | 5.9 | −15.4593 | 1.22465 |
| S | 2 | 121.5 | −11.8 | 8.85 | −15.2848 | 1.26744 |
| S | 5 | 121.5 | −17.7 | 2.95 | −14.4889 | 1.18112 |
| S | 5 | 40.5 | −17.7 | 2.95 | −12.4815 | 1.69905 |
| S | 5 | 40.5 | −17.7 | 5.9 | −11.8339 | 2.30619 |
| S | 5 | 40.5 | −5.9 | 5.9 | −11.6458 | 1.53988 |
| S | 5 | 121.5 | −5.9 | 8.85 | −11.4528 | 1.35531 |
| S | 5 | 121.5 | −11.8 | 5.9 | −11.1825 | 1.20141 |
| S | 5 | 121.5 | −11.8 | 2.95 | −11.1474 | 0.64429 |
| S | 5 | 81 | −11.8 | 2.95 | −11.086 | 2.0156 |
| S | 5 | 81 | −17.7 | 8.85 | −10.8339 | 1.56324 |
| S | 5 | 81 | −17.7 | 5.9 | −10.8318 | 1.68521 |
| S | 5 | 40.5 | −11.8 | 8.85 | −10.7829 | 1.5884 |
| S | 5 | 121.5 | −5.9 | 2.95 | −10.4846 | 1.34199 |
| S | 5 | 121.5 | −17.7 | 8.85 | −10.326 | 1.72217 |
| S | 5 | 40.5 | −17.7 | 8.85 | −10.2183 | 1.44533 |
| S | 5 | 81 | −5.9 | 8.85 | −10.194 | 1.37063 |
| S | 5 | 81 | −5.9 | 5.9 | −9.9493 | 1.45751 |
| S | 5 | 81 | −17.7 | 2.95 | −9.4543 | 1.04144 |
| S | 5 | 121.5 | −5.9 | 5.9 | −9.1624 | 1.34647 |
| S | 5 | 40.5 | −5.9 | 2.95 | −9.1288 | 1.32941 |
| S | 5 | 81 | −5.9 | 2.95 | −9.0484 | 1.69432 |
| S | 5 | 81 | −11.8 | 8.85 | −8.9969 | 1.10054 |
| S | 5 | 121.5 | −17.7 | 5.9 | −8.9963 | 1.20646 |
| S | 5 | 40.5 | −5.9 | 8.85 | −8.9775 | 1.07245 |
| S | 5 | 81 | −11.8 | 5.9 | −8.8982 | 1.52748 |
| S | 5 | 40.5 | −11.8 | 5.9 | −8.8753 | 1.46666 |
| S | 5 | 121.5 | −11.8 | 8.85 | −8.2082 | 1.74489 |
| S | 5 | 40.5 | −11.8 | 2.95 | −8.1124 | 1.61702 |
| S | 3 | 81 | −17.7 | 2.95 | 5.7463 | 1.19986 |
| S | 3 | 121.5 | −5.9 | 2.95 | 6.9368 | 1.19461 |
| S | 3 | 121.5 | −11.8 | 2.95 | 7.0698 | 1.60668 |
| S | 3 | 40.5 | −5.9 | 5.9 | 7.4676 | 1.26234 |
| S | 3 | 121.5 | −17.7 | 8.85 | 7.9274 | 2.37382 |
| S | 3 | 81 | −11.8 | 2.95 | 8.0625 | 1.21839 |
| S | 3 | 121.5 | −17.7 | 2.95 | 8.1858 | 1.74892 |
| S | 3 | 121.5 | −11.8 | 8.85 | 8.3687 | 1.68488 |
| S | 3 | 81 | −17.7 | 5.9 | 8.769 | 1.20623 |
| S | 3 | 81 | −5.9 | 5.9 | 8.7705 | 2.01796 |
| S | 3 | 121.5 | −17.7 | 5.9 | 9.07 | 1.14622 |
| S | 3 | 81 | −5.9 | 8.85 | 9.1933 | 1.32887 |
| S | 3 | 121.5 | −5.9 | 5.9 | 9.2115 | 2.29546 |
| S | 3 | 81 | −11.8 | 8.85 | 9.3361 | 1.16017 |
| S | 3 | 121.5 | −5.9 | 8.85 | 9.4484 | 1.99988 |
| S | 3 | 40.5 | −11.8 | 2.95 | 9.4942 | 1.59495 |
| S | 3 | 40.5 | −17.7 | 2.95 | 9.5241 | 0.96384 |
| S | 3 | 40.5 | −5.9 | 8.85 | 9.7919 | 1.34609 |
| S | 3 | 81 | −5.9 | 2.95 | 10.1062 | 1.17392 |
| S | 3 | 40.5 | −17.7 | 8.85 | 10.488 | 1.46559 |
| S | 3 | 40.5 | −11.8 | 5.9 | 10.5057 | 1.4 |
| S | 3 | 40.5 | −17.7 | 5.9 | 10.9389 | 1.40574 |
| S | 3 | 81 | −17.7 | 8.85 | 11.3412 | 1.81075 |
| S | 3 | 40.5 | −5.9 | 2.95 | 11.5181 | 1.61825 |
| S | 3 | 40.5 | −11.8 | 8.85 | 11.5577 | 1.51793 |
| S | 1 | 81 | −5.9 | 8.85 | 12.1613 | 1.08984 |
| S | 3 | 81 | −11.8 | 5.9 | 12.3248 | 1.31007 |
| S | 1 | 40.5 | −17.7 | 8.85 | 12.4598 | 0.73759 |
| S | 3 | 121.5 | −11.8 | 5.9 | 12.6061 | 1.69381 |
| S | 1 | 40.5 | −5.9 | 8.85 | 12.6976 | 0.83131 |
| S | 1 | 121.5 | −5.9 | 8.85 | 12.9487 | 0.87503 |
| S | 1 | 40.5 | −11.8 | 8.85 | 13.161 | 0.65166 |
| S | 1 | 81 | −5.9 | 5.9 | 13.2542 | 1.24965 |
| S | 4 | 40.5 | −17.7 | 8.85 | 13.3488 | 0.84689 |
| S | 4 | 121.5 | −5.9 | 5.9 | 13.43 | 0.94639 |
| S | 1 | 121.5 | −11.8 | 8.85 | 13.4307 | 0.79507 |
| S | 4 | 121.5 | −17.7 | 2.95 | 13.538 | 0.8239 |
| S | 4 | 121.5 | −5.9 | 8.85 | 13.6748 | 0.94927 |
| S | 1 | 121.5 | −17.7 | 8.85 | 13.6936 | 1.13156 |
| S | 4 | 81 | −11.8 | 8.85 | 13.9784 | 0.9137 |
| S | 4 | 121.5 | −17.7 | 8.85 | 14.136 | 0.6963 |
| S | 1 | 81 | −17.7 | 8.85 | 14.2105 | 1.28307 |
| S | 4 | 81 | −5.9 | 5.9 | 14.232 | 1.22346 |
| S | 1 | 40.5 | −11.8 | 5.9 | 14.3499 | 0.55432 |
| S | 4 | 81 | −5.9 | 8.85 | 14.4238 | 0.75313 |
| S | 4 | 81 | −17.7 | 8.85 | 14.4827 | 0.67621 |
| S | 4 | 40.5 | −5.9 | 8.85 | 14.5695 | 1.16596 |
| S | 4 | 40.5 | −11.8 | 5.9 | 14.6059 | 0.9416 |
| S | 4 | 121.5 | −11.8 | 8.85 | 14.6991 | 1.14665 |
| S | 1 | 121.5 | −11.8 | 5.9 | 14.7207 | 1.31273 |
| S | 4 | 81 | −17.7 | 5.9 | 14.7927 | 0.97423 |
| S | 4 | 40.5 | −11.8 | 8.85 | 14.8966 | 0.72277 |
| S | 1 | 81 | −11.8 | 5.9 | 14.981 | 0.6134 |
| S | 4 | 121.5 | −11.8 | 5.9 | 15.0911 | 0.49091 |
| S | 1 | 81 | −17.7 | 5.9 | 15.4862 | 0.83027 |
| S | 1 | 81 | −11.8 | 8.85 | 15.6044 | 1.1972 |
| S | 1 | 121.5 | −5.9 | 5.9 | 15.802 | 1.01271 |
| S | 1 | 121.5 | −5.9 | 2.95 | 16.0068 | 0.63441 |
| S | 1 | 81 | −11.8 | 2.95 | 16.0818 | 0.61363 |
| S | 1 | 121.5 | −17.7 | 5.9 | 16.1907 | 0.93458 |
| S | 4 | 121.5 | −5.9 | 2.95 | 16.3923 | 1.17033 |
| S | 1 | 121.5 | −11.8 | 2.95 | 16.4771 | 1.13685 |
| S | 1 | 121.5 | −17.7 | 2.95 | 16.9724 | 0.70408 |
| S | 4 | 81 | −11.8 | 5.9 | 17.147 | 0.618 |
| S | 4 | 81 | −11.8 | 2.95 | 17.2736 | 1.16917 |
| S | 4 | 121.5 | −11.8 | 2.95 | 17.2909 | 0.97641 |
| S | 4 | 121.5 | −17.7 | 5.9 | 17.3312 | 0.7286 |
| Weak | | | | | | |
| Competition | | | | | | |
| W | 2 | 38 | −2.24 | 1.26 | −0.9749 | 0.54194 |
| W | 2 | 38 | −4.48 | 0.84 | −0.9474 | 0.6117 |
| W | 1 | 114 | −6.72 | 0.42 | −0.9191 | 0.29077 |
| W | 2 | 76 | −6.72 | 0.84 | −0.8182 | 0.53931 |
| W | 2 | 38 | −6.72 | 1.26 | −0.8052 | 0.39893 |
| W | 2 | 114 | −2.24 | 0.42 | −0.7865 | 0.41132 |
| W | 2 | 76 | −4.48 | 0.84 | −0.6784 | 0.39832 |
| W | 2 | 114 | −6.72 | 0.84 | −0.4775 | 0.60078 |
| W | 1 | 76 | −4.48 | 0.42 | −0.434 | 0.34197 |
| W | 5 | 114 | −2.24 | 1.26 | −0.4205 | 0.27892 |
| W | 5 | 114 | −6.72 | 0.84 | −0.359 | 0.46776 |
| W | 2 | 114 | −6.72 | 1.26 | −0.28 | 0.4132 |
| W | 4 | 38 | −6.72 | 1.26 | −0.2703 | 0.45743 |
| W | 5 | 38 | −4.48 | 0.42 | −0.2697 | 0.7581 |
| W | 1 | 76 | −6.72 | 0.84 | −0.2518 | 0.36034 |
| W | 2 | 76 | −6.72 | 1.26 | −0.1944 | 0.45606 |
| W | 2 | 38 | −4.48 | 1.26 | −0.1724 | 0.44771 |
| W | 5 | 114 | −4.48 | 1.26 | −0.1438 | 0.72323 |
| W | 1 | 38 | −6.72 | 1.26 | −0.0917 | 0.29103 |
| W | 2 | 114 | −6.72 | 0.42 | −0.0285 | 0.62108 |
| W | 4 | 38 | −4.48 | 0.84 | 0.0704 | 0.62758 |
| W | 2 | 76 | −4.48 | 0.42 | 0.1218 | 0.55181 |
| W | 2 | 114 | −2.24 | 1.26 | 0.143 | 0.57704 |
| W | 5 | 114 | −4.48 | 0.84 | 0.1502 | 0.56848 |
| W | 5 | 38 | −6.72 | 0.84 | 0.159 | 0.60961 |
| W | 5 | 76 | −4.48 | 1.26 | 0.1883 | 0.51424 |
| W | 2 | 114 | −2.24 | 0.84 | 0.2615 | 0.42218 |
| W | 2 | 114 | −4.48 | 1.26 | 0.3166 | 0.4981 |
| W | 5 | 38 | −2.24 | 0.42 | 0.3577 | 0.56775 |
| W | 2 | 114 | −4.48 | 0.84 | 0.3625 | 0.6282 |
| W | 5 | 38 | −2.24 | 1.26 | 0.4186 | 0.46659 |
| W | 4 | 76 | −6.72 | 1.26 | 0.4462 | 0.56159 |
| W | 4 | 76 | −4.48 | 1.26 | 0.4556 | 0.43945 |
| W | 2 | 76 | −2.24 | 0.84 | 0.514 | 0.34063 |
| W | 5 | 114 | −2.24 | 0.42 | 0.5444 | 0.48594 |
| W | 5 | 76 | −6.72 | 0.42 | 0.5631 | 0.68002 |
| W | 5 | 114 | −6.72 | 0.42 | 0.5742 | 0.6828 |
| W | 1 | 76 | −4.48 | 0.84 | 0.6512 | 0.34964 |
| W | 5 | 76 | −6.72 | 1.26 | 0.6573 | 0.59332 |
| W | 5 | 38 | −4.48 | 1.26 | 0.6844 | 0.49293 |
| W | 5 | 38 | −6.72 | 1.26 | 0.7285 | 0.60998 |
| W | 1 | 76 | −6.72 | 1.26 | 0.7394 | 0.31661 |
| W | 5 | 76 | −2.24 | 1.26 | 0.7406 | 0.56284 |
| W | 2 | 76 | −2.24 | 1.26 | 0.746 | 0.5014 |
| W | 4 | 114 | −2.24 | 1.26 | 0.7726 | 0.40664 |
| W | 5 | 76 | −2.24 | 0.84 | 0.792 | 0.59947 |
| W | 2 | 114 | −4.48 | 0.42 | 0.8175 | 0.36531 |
| W | 4 | 38 | −4.48 | 1.26 | 0.8591 | 0.38691 |
| W | 5 | 76 | −2.24 | 0.42 | 0.8937 | 0.37935 |
| W | 1 | 38 | −4.48 | 1.26 | 0.8985 | 0.58065 |
| W | 5 | 38 | −6.72 | 0.42 | 0.8993 | 0.56644 |
| W | 4 | 114 | −4.48 | 0.84 | 0.9458 | 0.71344 |
| W | 4 | 114 | −6.72 | 0.42 | 0.9545 | 0.46238 |
| W | 4 | 76 | −2.24 | 1.26 | 0.9869 | 0.43704 |
| W | 1 | 114 | −4.48 | 1.26 | 0.9885 | 0.51052 |
| W | 2 | 76 | −4.48 | 1.26 | 1.0123 | 0.69319 |
| W | 1 | 114 | −6.72 | 0.84 | 1.059 | 0.25207 |
| W | 4 | 114 | −6.72 | 0.84 | 1.0734 | 0.47198 |
| W | 4 | 114 | −4.48 | 1.26 | 1.0849 | 0.64469 |
| W | 1 | 114 | −6.72 | 1.26 | 1.0901 | 0.48651 |
| W | 1 | 38 | −4.48 | 0.84 | 1.1084 | 0.4891 |
| W | 4 | 76 | −4.48 | 0.42 | 1.1174 | 0.64077 |
| W | 5 | 38 | −4.48 | 0.84 | 1.1667 | 0.64458 |
| W | 4 | 114 | −2.24 | 0.84 | 1.2198 | 0.5183 |
| W | 5 | 114 | −6.72 | 1.26 | 1.235 | 0.68571 |
| W | 5 | 76 | −6.72 | 0.84 | 1.2498 | 0.37942 |
| W | 1 | 114 | −4.48 | 0.42 | 1.2927 | 0.35122 |
| W | 4 | 114 | −6.72 | 1.26 | 1.3368 | 0.44392 |
| W | 5 | 76 | −4.48 | 0.84 | 1.3742 | 0.47363 |
| W | 5 | 114 | −2.24 | 0.84 | 1.4777 | 0.53485 |
| W | 4 | 114 | −4.48 | 0.42 | 1.4822 | 0.68512 |
| W | 1 | 114 | −4.48 | 0.84 | 1.563 | 0.3806 |
| W | 5 | 38 | −2.24 | 0.84 | 1.6311 | 0.38344 |
| W | 4 | 76 | −2.24 | 0.84 | 1.6934 | 0.44344 |
| W | 4 | 76 | −4.48 | 0.84 | 1.6939 | 0.68717 |
| W | 4 | 76 | −6.72 | 0.84 | 1.6976 | 0.46064 |
| W | 1 | 38 | −2.24 | 1.26 | 1.8683 | 0.45814 |
| W | 5 | 76 | −4.48 | 0.42 | 1.8953 | 0.38429 |
| W | 4 | 114 | −2.24 | 0.42 | 1.903 | 0.31302 |
| W | 5 | 114 | −4.48 | 0.42 | 1.9525 | 0.46925 |
| W | 4 | 38 | −2.24 | 1.26 | 2.0061 | 0.76157 |
| W | 1 | 76 | −4.48 | 1.26 | 2.045 | 0.47028 |
| W | 1 | 114 | −2.24 | 0.42 | 2.377 | 0.35322 |
| W | 1 | 76 | −2.24 | 1.26 | 2.3877 | 0.59782 |
| W | 1 | 76 | −2.24 | 0.84 | 2.7483 | 0.59472 |
| W | 1 | 114 | −2.24 | 1.26 | 2.8316 | 0.51897 |
| W | 1 | 114 | −2.24 | 0.84 | 2.9704 | 0.45145 |
| W | 3 | 114 | −2.24 | 0.84 | 4.3453 | 0.47572 |
| W | 3 | 76 | −4.48 | 0.42 | 4.5239 | 0.37921 |
| W | 3 | 76 | −2.24 | 0.42 | 4.6835 | 0.52407 |
| W | 3 | 38 | −2.24 | 1.26 | 5.0778 | 0.45692 |
| W | 3 | 114 | −6.72 | 0.42 | 5.1046 | 0.47891 |
| W | 3 | 38 | −6.72 | 1.26 | 5.1172 | 0.43762 |
| W | 3 | 76 | −6.72 | 0.42 | 5.1531 | 0.46859 |
| W | 3 | 114 | −2.24 | 1.26 | 5.1627 | 0.55367 |
| W | 3 | 38 | −2.24 | 0.42 | 5.1886 | 0.49492 |
| W | 3 | 114 | −4.48 | 0.84 | 5.2269 | 0.57921 |
| W | 3 | 38 | −6.72 | 0.42 | 5.2521 | 0.47999 |
| W | 3 | 114 | −6.72 | 0.84 | 5.2823 | 0.51724 |
| W | 3 | 38 | −4.48 | 1.26 | 5.2859 | 0.51621 |
| W | 3 | 114 | −2.24 | 0.42 | 5.2943 | 0.51426 |
| W | 3 | 76 | −4.48 | 1.26 | 5.3139 | 0.6699 |
| W | 3 | 114 | −6.72 | 1.26 | 5.408 | 0.54272 |
| W | 3 | 38 | −6.72 | 0.84 | 5.4807 | 0.51845 |
| W | 3 | 76 | −6.72 | 1.26 | 5.5691 | 0.48704 |
| W | 3 | 76 | −2.24 | 0.84 | 5.6016 | 0.73385 |
| W | 3 | 38 | −4.48 | 0.84 | 5.7016 | 0.52758 |
| W | 3 | 114 | −4.48 | 0.42 | 5.7885 | 0.42303 |
| W | 3 | 38 | −2.24 | 0.84 | 6.0548 | 0.75621 |
| W | 3 | 76 | −6.72 | 0.84 | 6.1215 | 0.73471 |
| W | 3 | 76 | −4.48 | 0.84 | 6.1255 | 0.38342 |
| W | 3 | 38 | −4.48 | 0.42 | 6.1417 | 0.73321 |
| W | 3 | 114 | −4.48 | 1.26 | 6.4012 | 0.34036 |
| W | 3 | 76 | −2.24 | 1.26 | 6.6463 | 0.52828 |

TABLE 8
Mean response and variation in response with a range of
parameters used for selection in each case.

| Competition | | | |
|---|---|---|---|
| Strong(s) | | Response per | Standard |
| Weak (w) | Case | generation | Error |
| S | 1 | 14.5345 | 0.33375 |
| S | 2 | −18.0398 | 0.32908 |
| S | 3 | 9.3985 | 0.32304 |
| S | 4 | 14.9667 | 0.30321 |
| S | 5 | −10.2518 | 0.27755 |
| W | 1 | 1.2461 | 0.25065 |
| W | 2 | −0.0934 | 0.13854 |
| W | 3 | 5.4464 | 0.10517 |
| W | 4 | 1.0765 | 0.13316 |
| W | 5 | 0.7089 | 0.12495 |

For strong associative effects CE BLUP is superior and insensitive to parameter estimates. With weak associative effects, the most robust solution is reduced FGAM BLUP in Half Sib family groups. However, these results suggest that with weak associative effects CE BLUP is still superior to AM-BLUP in random groups and is somewhat insensitive to parameter estimates. Further, with weak associative effects, selection using Case 5 does not appear to be antagonistic to Case 3 or 4.

Comparison of Correlations Between True and Estimated Breeding Values with Biased Parameters

Correlations between true and estimated breeding values for direct and associate effects were estimated for a range of true genetic parameters, group size, and amount of data. Bias was induced in the estimates of true parameters and impacts on genetic correlations was observed.

Associate effects: Magnitude of Associate effect has major effects; Heritability and Number of generations of data had minor effects; Group size and 50% bias in estimates used have little or no effect

Direct effects: Magnitude of Heritability has major effect; magnitude of associate effects and number of generations of data have minor effect Group size and 50% bias in estimates used have little or no effect

Conditions for the Simulations:

1. Many Generations of Data

10 Generations of data

256 animals measured per generation. 32 males and 128 females selected per generation

2. Few Generations of Data

3 Generations of data:

576 animals measured per generation, 36 males and 144 females selected per generation Genetic Parameters for both simulations are given in the following Table.

TABLE 9
Genetic Parameters

| Generations of | | | | True Values | | | |
|---|---|---|---|---|---|---|---|
| data | Group Size | Heritability | Assoc | Sig(d) | Cov(a, d) | Sig(a) | Sig(e) |
| 10 | 16 | high | high | 72 | −49 | 122 | 18 |
| 10 | 16 | high | low | 70 | −9 | 7.5 | 18 |
| 10 | 4 | high | high | 72 | −49 | 122 | 18 |
| 10 | 4 | high | low | 70 | −9 | 7.5 | 18 |
| 10 | 16 | low | high | 72 | −49 | 122 | 170 |
| 10 | 16 | low | low | 70 | −9 | 7.5 | 170 |
| 10 | 4 | low | high | 72 | −49 | 122 | 170 |
| 10 | 4 | low | low | 70 | −9 | 7.5 | 170 |
| 3 | 16 | high | high | 72 | −49 | 122 | 18 |
| 3 | 16 | high | low | 70 | −9 | 7.5 | 18 |
| 3 | 4 | high | high | 72 | −49 | 122 | 18 |
| 3 | 4 | high | low | 70 | −9 | 7.5 | 18 |
| 3 | 16 | low | high | 72 | −49 | 122 | 170 |
| 3 | 16 | low | low | 70 | −9 | 7.5 | 170 |
| 3 | 4 | low | high | 72 | −49 | 122 | 170 |
| 3 | 4 | low | low | 70 | −9 | 7.5 | 170 |

TABLE 10
Bias Used in estimates of Effects

| Code | Bias In Estimates |
|---|---|
| ccc | all correct values |
| cch | Sig(a) 50% high |
| ccl | Sig(a) 50% low |
| chc | Sig(a, d) 50% high |
| clc | Sig(a, d) 50% low |
| hcc | Sig(d) 50% high |
| lcc | Sig(d) 50% low |

TABLE 11
Data set 1: Ten generations of data (Raw data in Table 12)

| | |
|---|---|
| Mean | SD |

Associate Effect Correlation Means

| | | | |
|---|---|---|---|
| HERIT | High (.8) | 0.807932 | 0.110334 |
| | Low (.3) | 0.700423 | 0.116133 |
| GROUP SIZE | 4 | 0.765674 | 0.137255 |
| | 16 | 0.73485 | 0.1095 |
| ASSOC EFFECT | High | 0.852661 | 0.053857 |
| | Low | 0.637425 | 0.070356 |
| BIAS IN ESTIMATES | ccc | 0.735713 | 0.144015 |
| | cch | 0.756971 | 0.130327 |
| | ccl | 0.748971 | 0.130393 |
| | chc | 0.75602 | 0.126521 |
| | clc | 0.751104 | 0.137621 |
| | hcc | 0.75388 | 0.13137 |
| | lcc | 0.756351 | 0.125917 |

Direct Effect Correlation Means

| | | | |
|---|---|---|---|
| HERIT | high | 0.831044 | 0.042217 |
| | low | 0.697746 | 0.009987 |
| GROUP | 4 | 0.765891 | 0.080272 |
| | 16 | 0.754722 | 0.065992 |
| ASSOC | high | 0.751818 | 0.057099 |
| | low | 0.770484 | 0.088392 |
| VAL | ccc | 0.758564 | 0.069192 |
| | cch | 0.747323 | 0.071559 |
| | ccl | 0.770885 | 0.078394 |
| | chc | 0.771054 | 0.080299 |
| | clc | 0.74627 | 0.075718 |
| | hcc | 0.755197 | 0.074524 |
| | lcc | 0.770933 | 0.088275 |

| Source | DF | Mean Square | F Value | Pr > F |
|---|---|---|---|---|
| HERIT | 1 | 0.152657 | 115.82 | 0.0001 |
| GROUP | 1 | 0.007875 | 5.97 | 0.0187 |
| ASSOC | 1 | 0.588855 | 446.75 | 0.0001 |
| VAL | 6 | 0.000484 | 0.37 | 0.8955 |

| Source | DF | Mean Square | F Value | Pr > F |
|---|---|---|---|---|
| HERIT | 1 | 0.23478 | 295.56 | 0.0001 |
| GROUP | 1 | 5.32E−05 | 0.07 | 0.797 |
| ASSOC | 1 | 0.008888 | 11.19 | 0.0017 |
| VAL | 6 | 0.00031 | 0.39 | 0.8816 |

TABLE 12
Correlation of Estimated Effect with True Effect
with 10 generations of data

| | | | | | |
|---|---|---|---|---|---|
| | | | Biased | | Correlation |
| | Group | Assoc | Values | | of Effect |
| Heritability | Size | Effect | Used | Effect | with True |

Associate Effect

| | | | | | |
|---|---|---|---|---|---|
| high | 4 | high | ccc | ASSOC | 0.92835 |
| high | 4 | high | cch | ASSOC | 0.92641 |
| high | 4 | high | ccl | ASSOC | 0.92253 |
| high | 4 | high | chc | ASSOC | 0.92519 |
| high | 4 | high | clc | ASSOC | 0.92788 |
| high | 4 | high | hcc | ASSOC | 0.9262 |
| high | 4 | high | lcc | ASSOC | 0.9233 |
| high | 4 | low | ccc | ASSOC | 0.73638 |
| high | 4 | low | cch | ASSOC | 0.73497 |
| high | 4 | low | ccl | ASSOC | 0.73496 |
| high | 4 | low | chc | ASSOC | 0.73236 |
| high | 4 | low | clc | ASSOC | 0.73385 |
| high | 4 | low | hcc | ASSOC | 0.73352 |
| high | 4 | low | lcc | ASSOC | 0.72905 |
| high | 16 | high | ccc | ASSOC | 0.8648 |
| high | 16 | high | cch | ASSOC | 0.83551 |
| high | 16 | high | ccl | ASSOC | 0.89243 |
| high | 16 | high | chc | ASSOC | 0.8914 |
| high | 16 | high | clc | ASSOC | 0.8346 |
| high | 16 | high | hcc | ASSOC | 0.83297 |
| high | 16 | high | lcc | ASSOC | 0.88903 |
| high | 16 | low | ccc | ASSOC | 0.54673 |
| high | 16 | low | ccl | ASSOC | 0.64145 |
| high | 16 | low | chc | ASSOC | 0.66713 |
| high | 16 | low | lcc | ASSOC | 0.6873 |
| low | 4 | high | ccc | ASSOC | 0.84049 |
| low | 4 | high | cch | ASSOC | 0.84153 |
| low | 4 | high | ccl | ASSOC | 0.83234 |
| low | 4 | high | chc | ASSOC | 0.84222 |
| low | 4 | high | clc | ASSOC | 0.83773 |
| low | 4 | high | hcc | ASSOC | 0.83771 |
| low | 4 | high | lcc | ASSOC | 0.84101 |
| low | 4 | low | ccc | ASSOC | 0.56761 |
| low | 4 | low | cch | ASSOC | 0.55677 |
| low | 4 | low | ccl | ASSOC | 0.57414 |
| low | 4 | low | chc | ASSOC | 0.57968 |
| low | 4 | low | clc | ASSOC | 0.54236 |
| low | 4 | low | hcc | ASSOC | 0.56396 |
| low | 4 | low | lcc | ASSOC | 0.56638 |
| low | 16 | high | ccc | ASSOC | 0.78434 |
| low | 16 | high | cch | ASSOC | 0.78314 |
| low | 16 | high | ccl | ASSOC | 0.77951 |
| low | 16 | high | chc | ASSOC | 0.7855 |
| low | 16 | high | clc | ASSOC | 0.78212 |
| low | 16 | high | hcc | ASSOC | 0.78162 |
| low | 16 | high | lcc | ASSOC | 0.78464 |
| low | 16 | low | ccc | ASSOC | 0.617 |
| low | 16 | low | cch | ASSOC | 0.62047 |
| low | 16 | low | ccl | ASSOC | 0.61441 |
| low | 16 | low | chc | ASSOC | 0.62468 |
| low | 16 | low | clc | ASSOC | 0.59919 |
| low | 16 | low | hcc | ASSOC | 0.60118 |
| low | 16 | low | lcc | ASSOC | 0.6301 |

Direct Effects

| | | | | | |
|---|---|---|---|---|---|
| high | 4 | high | ccc | DIRECT | 0.81048 |
| high | 4 | high | cch | DIRECT | 0.80812 |
| high | 4 | high | ccl | DIRECT | 0.80112 |
| high | 4 | high | chc | DIRECT | 0.78629 |
| high | 4 | high | clc | DIRECT | 0.80297 |
| high | 4 | high | hcc | DIRECT | 0.80813 |
| high | 4 | high | lcc | DIRECT | 0.79251 |
| high | 4 | low | ccc | DIRECT | 0.8798 |
| high | 4 | low | cch | DIRECT | 0.87868 |
| high | 4 | low | ccl | DIRECT | 0.87964 |
| high | 4 | low | chc | DIRECT | 0.87914 |
| high | 4 | low | clc | DIRECT | 0.87992 |
| high | 4 | low | hcc | DIRECT | 0.87891 |
| high | 4 | low | lcc | DIRECT | 0.86748 |
| high | 16 | high | ccc | DIRECT | 0.81094 |
| high | 16 | high | cch | DIRECT | 0.75053 |
| high | 16 | high | ccl | DIRECT | 0.84244 |
| high | 16 | high | chc | DIRECT | 0.83872 |
| high | 16 | high | clc | DIRECT | 0.77644 |
| high | 16 | high | hcc | DIRECT | 0.80341 |
| high | 16 | high | lcc | DIRECT | 0.83886 |
| high | 16 | low | ccc | DIRECT | 0.76233 |
| high | 16 | low | ccl | DIRECT | 0.84187 |
| high | 16 | low | chc | DIRECT | 0.86226 |
| high | 16 | low | lcc | DIRECT | 0.89512 |
| low | 4 | high | ccc | DIRECT | 0.70597 |
| low | 4 | high | cch | DIRECT | 0.70048 |
| low | 4 | high | ccl | DIRECT | 0.70583 |
| low | 4 | high | chc | DIRECT | 0.70052 |
| low | 4 | high | clc | DIRECT | 0.68166 |
| low | 4 | high | hcc | DIRECT | 0.69536 |
| low | 4 | high | lcc | DIRECT | 0.70096 |
| low | 4 | low | ccc | DIRECT | 0.68864 |
| low | 4 | low | cch | DIRECT | 0.6859 |
| low | 4 | low | ccl | DIRECT | 0.69057 |
| low | 4 | low | chc | DIRECT | 0.69062 |
| low | 4 | low | clc | DIRECT | 0.68515 |
| low | 4 | low | hcc | DIRECT | 0.68798 |
| low | 4 | low | lcc | DIRECT | 0.67212 |
| low | 16 | high | ccc | DIRECT | 0.70356 |
| low | 16 | high | cch | DIRECT | 0.70251 |
| low | 16 | high | ccl | DIRECT | 0.6937 |
| low | 16 | high | chc | DIRECT | 0.69386 |
| low | 16 | high | clc | DIRECT | 0.69672 |
| low | 16 | high | hcc | DIRECT | 0.70402 |
| low | 16 | high | lcc | DIRECT | 0.6948 |
| low | 16 | low | ccc | DIRECT | 0.70679 |
| low | 16 | low | cch | DIRECT | 0.70504 |
| low | 16 | low | ccl | DIRECT | 0.71191 |
| low | 16 | low | chc | DIRECT | 0.71702 |
| low | 16 | low | clc | DIRECT | 0.70103 |
| low | 16 | low | hcc | DIRECT | 0.70857 |
| low | 16 | low | lcc | DIRECT | 0.70561 |

Summary: Associate effects, Magnitude of Heritability and Associate effects have major effects. Groups size and 50% bias in estimates used have little or no effect Direct effects, Magnitude of Heritability and Associate effects have major effects, groups size and 50% bias in estimates used have little or no effect

TABLE 13
Data set 2: Three generations of data (Raw data in Table 14)

| | |
|---|---|
| Mean | SD |

Associate Effect Means

| | | | |
|---|---|---|---|
| HERIT | high | 0.69706 | 0.174847 |
| | low | 0.6868 | 0.113338 |
| GROUP | 4 | 0.69714 | 0.107627 |
| | 16 | 0.68674 | 0.164041 |
| ASSOC | high | 0.80715 | 0.040799 |
| | low | 0.60423 | 0.126504 |
| VAL | ccc | 0.70936 | 0.105517 |
| | cch | 0.69072 | 0.107953 |
| | ccl | 0.71314 | 0.110852 |
| | chc | 0.71308 | 0.111916 |
| | clc | 0.69337 | 0.10719 |
| | hcc | 0.60733 | 0.279885 |
| | lcc | 0.71138 | 0.11092 |

Direct Effect Means

| | | | |
|---|---|---|---|
| HERIT | high | 0.83358 | 0.067235 |
| | low | 0.6601 | 0.01546 |
| GROUP | 4 | 0.73145 | 0.101553 |
| | 16 | 0.73311 | 0.095511 |
| ASSOC | high | 0.69709 | 0.048814 |
| | low | 0.75984 | 0.115909 |
| VAL | ccc | 0.73977 | 0.103576 |
| | cch | 0.72316 | 0.104348 |
| | ccl | 0.74433 | 0.106612 |
| | chc | 0.74223 | 0.106119 |
| | clc | 0.72644 | 0.105941 |
| | hcc | 0.71024 | 0.087641 |
| | lcc | 0.73735 | 0.10508 |

Analysis of Associate Effects

| Source | DF | Mean Square | F Value | Pr > F |
|---|---|---|---|---|
| HERIT | 1 | 0.00126 | 0.14 | 0.7073 |
| GROUP | 1 | 0.00181 | 0.21 | 0.6532 |
| ASSOC | 1 | 0.55121 | 62.48 | 0.0001 |
| VAL | 6 | 0.01019 | 1.16 | 0.3498 |

Analysis of Direct Effects

| Source | DF | Mean Square | F Value | Pr > F |
|---|---|---|---|---|
| HERIT | 1 | 0.35113 | 192.06 | 0.0001 |
| GROUP | 1 | 0.00698 | 3.82 | 0.0581 |
| ASSOC | 1 | 0.01291 | 7.06 | 0.0115 |
| VAL | 6 | 0.0005 | 0.27 | 0.9469 |

TABLE 14
Correlation of Estimated Effect with True Effect
with3 generations of data

| | | | | |
|---|---|---|---|---|
| HERIT | GROUP | ASSOC | VAL | CORR |

Associate Effects

| | | | | |
|---|---|---|---|---|
| high | 4 | low | ccc | 0.68216 |
| high | 4 | low | cch | 0.67818 |
| high | 4 | low | ccl | 0.68098 |
| high | 4 | low | chc | 0.67245 |
| high | 4 | low | clc | 0.68567 |
| high | 4 | low | hcc | 0.68497 |
| high | 4 | low | lcc | 0.66702 |
| high | 16 | high | ccc | 0.83245 |
| high | 16 | high | cch | 0.80299 |
| high | 16 | high | ccl | 0.86617 |
| high | 16 | high | chc | 0.85989 |
| high | 16 | high | clc | 0.80346 |
| high | 16 | high | hcc | 0.8054 |
| high | 16 | high | lcc | 0.85685 |
| high | 16 | low | ccc | 0.69507 |
| high | 16 | low | cch | 0.60957 |
| high | 16 | low | ccl | 0.69797 |
| high | 16 | low | chc | 0.70541 |
| high | 16 | low | clc | 0.6334 |
| high | 16 | low | hcc | 0.01607 |
| high | 16 | low | lcc | 0.70207 |
| low | 4 | high | ccc | 0.83537 |
| low | 4 | high | cch | 0.83472 |
| low | 4 | high | ccl | 0.82937 |
| low | 4 | high | chc | 0.83543 |
| low | 4 | high | clc | 0.83343 |
| low | 4 | high | hcc | 0.83402 |
| low | 4 | high | lcc | 0.83411 |
| low | 4 | low | ccc | 0.58169 |
| low | 4 | low | cch | 0.57462 |
| low | 4 | low | ccl | 0.58395 |
| low | 4 | low | chc | 0.58482 |
| low | 4 | low | clc | 0.56455 |
| low | 4 | low | hcc | 0.57503 |
| low | 4 | low | lcc | 0.58735 |
| low | 16 | high | ccc | 0.75694 |
| low | 16 | high | cch | 0.75489 |
| low | 16 | high | ccl | 0.75203 |
| low | 16 | high | chc | 0.75671 |
| low | 16 | high | clc | 0.7546 |
| low | 16 | high | hcc | 0.75565 |
| low | 16 | high | lcc | 0.75573 |
| low | 16 | low | ccc | 0.58182 |
| low | 16 | low | cch | 0.58007 |
| low | 16 | low | ccl | 0.58148 |
| low | 16 | low | chc | 0.57683 |
| low | 16 | low | clc | 0.57847 |
| low | 16 | low | hcc | 0.5802 |
| low | 16 | low | lcc | 0.57651 |

Direct Effects

| | | | | |
|---|---|---|---|---|
| high | 4 | low | ccc | 0.87112 |
| high | 4 | low | cch | 0.87095 |
| high | 4 | low | ccl | 0.87011 |
| high | 4 | low | chc | 0.87129 |
| high | 4 | low | clc | 0.87096 |
| high | 4 | low | hcc | 0.86877 |
| high | 4 | low | lcc | 0.86302 |
| high | 16 | high | ccc | 0.76266 |
| high | 16 | high | cch | 0.66633 |
| high | 16 | high | ccl | 0.79983 |
| high | 16 | high | chc | 0.78643 |
| high | 16 | high | clc | 0.71414 |
| high | 16 | high | hcc | 0.75548 |
| high | 16 | high | lcc | 0.77934 |
| high | 16 | low | ccc | 0.8893 |
| high | 16 | low | cch | 0.87871 |
| high | 16 | low | ccl | 0.89052 |
| high | 16 | low | chc | 0.8913 |
| high | 16 | low | clc | 0.88439 |
| high | 16 | low | lcc | 0.88703 |
| low | 4 | high | ccc | 0.69112 |
| low | 4 | high | cch | 0.68493 |
| low | 4 | high | ccl | 0.68923 |
| low | 4 | high | chc | 0.68336 |
| low | 4 | high | clc | 0.66507 |
| low | 4 | high | hcc | 0.68085 |
| low | 4 | high | lcc | 0.6841 |
| low | 4 | low | ccc | 0.64396 |
| low | 4 | low | cch | 0.64403 |
| low | 4 | low | ccl | 0.64369 |
| low | 4 | low | chc | 0.64594 |
| low | 4 | low | clc | 0.64067 |
| low | 4 | low | hcc | 0.63978 |
| low | 4 | low | lcc | 0.63747 |
| low | 16 | high | ccc | 0.65959 |
| low | 16 | high | cch | 0.65756 |
| low | 16 | high | ccl | 0.65566 |
| low | 16 | high | chc | 0.65549 |
| low | 16 | high | clc | 0.65373 |
| low | 16 | high | hcc | 0.65835 |
| low | 16 | high | lcc | 0.65561 |
| low | 16 | low | ccc | 0.66067 |
| low | 16 | low | cch | 0.65962 |
| low | 16 | low | ccl | 0.66128 |
| low | 16 | low | chc | 0.66177 |
| low | 16 | low | clc | 0.65611 |
| low | 16 | low | hcc | 0.65823 |
| low | 16 | low | lcc | 0.6549 |

Associate effects, Magnitude of Associate effects has major effects, Heritability, groups size and 50% bias in estimates used have no effect. Direct effects, Magnitude of Heritability and Associate effects have major effects, has minor effect and 50% bias in estimates used and groups size have little or no effect

TABLE 15
Overall Means

| | | |
|---|---|---|
| GEN | Mean | SD |

Associative Effects

| | | |
|---|---|---|
| 3 | 0.69119571 | 0.14138622 |
| 10 | 0.75113453 | 0.12472818 |

Direct Effects

| | | |
|---|---|---|
| 3 | 0.73238438 | 0.09713733 |
| 10 | 0.76062283 | 0.07339878 |

TABLE 16
Overall Analysis Associate Effects

| Source | DF | Mean Square | F Value | Pr > F |
|---|---|---|---|---|
| GEN | 1 | 0.091472 | 18.99 | 0.0001 |
| HERIT | 1 | 0.094453 | 19.61 | 0.0001 |
| GROUP | 1 | 0.014593 | 3.03 | 0.0851 |
| ASSOC | 1 | 1.183439 | 245.71 | 0.0001 |
| VAL | 6 | 0.006286 | 1.31 | 0.2629 |

TABLE 17
Overall Analysis Direct Effect

| Source | DF | Mean Square | F Value | Pr > F |
|---|---|---|---|---|
| GEN | 1 | 0.020085 | 15.77 | 0.0001 |
| HERIT | 1 | 0.575804 | 452.1 | 0.0001 |
| GROUP | 1 | 0.002995 | 2.35 | 0.1287 |
| ASSOC | 1 | 0.026586 | 20.87 | 0.0001 |
| VAL | 6 | 0.000602 | 0.47 | 0.8272 |

Associate effects, Magnitude of Associate effect has major effects, Heritability and Number of generations of data has minor effect Group size and 50% bias in estimates used have no effect. Direct effects, Magnitude of Heritability has major effect, magnitude of associate effects and number of generations of data have minor effect Group size and 50% bias in estimates used have little or no effect

### Example 3

Biological Testing: Alternative Methods for Incorporation of Competitive Effects in Breeding Programs Using Japanese Ouail as a Model Organism

Alternative GS selection schemes (CE-BLUP, FGAM-BLUP, and AM-BLUP) were tested in order to provide a biological verification of the novel theory and computer simulations that incorporate competitive interactions into breeding programs and to further identify optimal response.

Three methods of selection were compared under two environmental conditions. The methods tested were:

1) Control (AM-BLUP): AM-BLUP selection without accounting for associative effects and individuals housed in random groups. This is the previously best known method and the method currently used in animal genetic improvement programs.

2) FGAM-BLUP. Competitive interactions are accounted for by group structure. This is the same as AM-BLUP except individuals are housed in half sib groups.

3) CE-BLUP. Competitive interactions are accounted for in the mixed model equations, and individuals are housed in random groups.

Environmental conditions were all cages had 12 birds per cage and 6 inches of feeders space per cage.

The trait of selection was weight at 43 days after hatch.

There are at least 3 ways to implement it: 1) Pure Group selection, 2) Selection within half sib family groups and, 3) use of a statistical model to account for the associate effects. These models have been evaluated with different genetic parameters via computer simulation. Results show that if associative effects are moderate, CE-BLUP is optimal. However, this assumes that parameters are estimated without error. In practice, this is never true, in which case FGAM-BLUP may be the best A biological simulation with a model organism was conducted to verify the computer simulation.

Four criteria are appropriate for an effective test of whether GS is superior to T-BLUP. These criteria are: 1) competition must be present, 2) generation interval must be short to allow rapid genetic change and timely results, 3) pedigrees and individual identification must be maintained, and 4) must be inexpensive to rear and maintain Quail meet all these criteria.

Eight rooms of the poultry grower house were used. Each room had 6 rows and 12 cages per row. Two rooms were used for brooding with the remaining allocated to the 3 treatment combinations (methods). For each replicate-selection line, 24 sires each mated to 2 dams were used to generate replacement chicks within each room. Four progeny per dam were housed, either at random or half sib groups depending on the methods of selection.

Upon hatch, chicks were toe clipped to designate dam and housed by sire family in the brooder rooms until to two weeks of age. At two weeks of age they were wing banded and transferred to growing cages. At 43 days of age the birds were weighed with selections made and transferred to mating cages by 49 days of age. In the mating cages, each dam was in an individual cage with the sire rotated three times a week. After selection quail were kept in holding cages until 10 weeks of age. At 10 weeks of age, breeders were culled from among those with the lowest Expected Breeding Values (EBV's) for the method of selection and replacements made from among 10 week old birds with the highest EBV's of the same method. Eggs were collected from the breeders for 14 days and the process repeated every 14 days for 28 hatches. Each egg was recorded and marked by cage to maintain pedigree information. Mating was continuous with overlapping generations. Matings with full or half sibs were avoided.

A small experiment was conducted with the first generation in order to examine the effect of pen density on growth and morbidity. Within each room, 9 densities were examined: 1, 2, 4, 8, 12, 16, 20, 24, 28 birds per pen each replicated in 6 cages except at the lowest density, which had 24 replicates. Results for this experiment indicated the optimal density used for the selection experiment Those of skill in the art would know to select the optimal density for a particular result.

In the first two generations, birds were mated at random and no selection occurred. Data from these first two generations were used for parameter estimation to be used in the alternative BLUP models Starting with the third generation, birds were selected based on their respective method of selection.

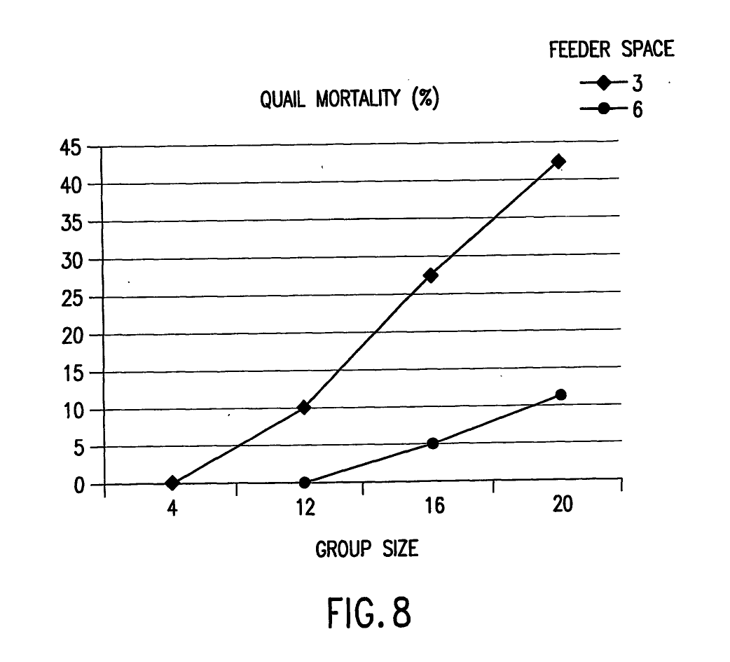

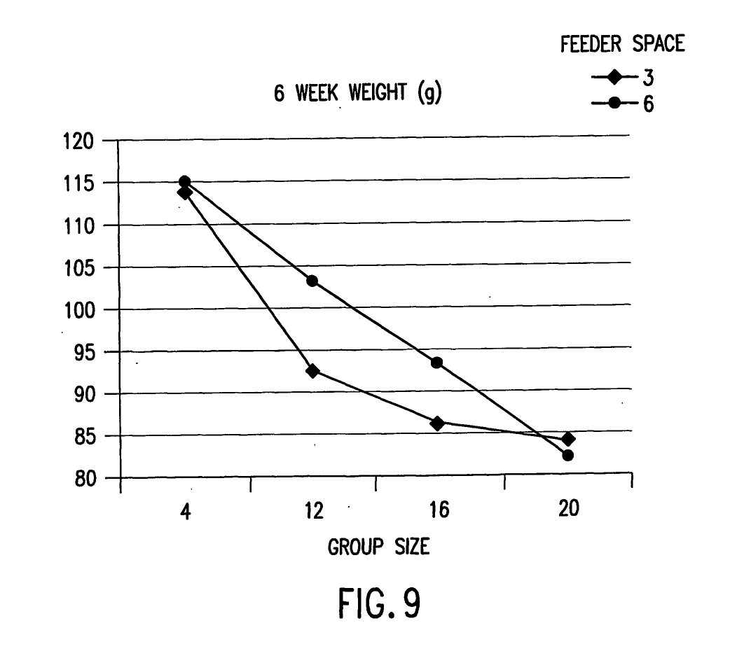

Initial Density Trials. The quail density experiment was performed at two different levels of feed restriction, 3 and 6 inch feeder space. The 3 inch feeder space was too severe in restriction to achieve the magnitude of restriction desired. The 6 in feeder space resulted in a linear decline in average weight with increasing number of quail per pen. At 12 birds per cage a 12% decline in weight and a 0% increase in mortality was achieved (FIGS. 8 and 9). This combination was therefore used in all subsequent experiments. While this density was preferred in this experiment, one of skill in the art would know to use other densities to achieve the desired magnitude of restriction.

Selection Results:

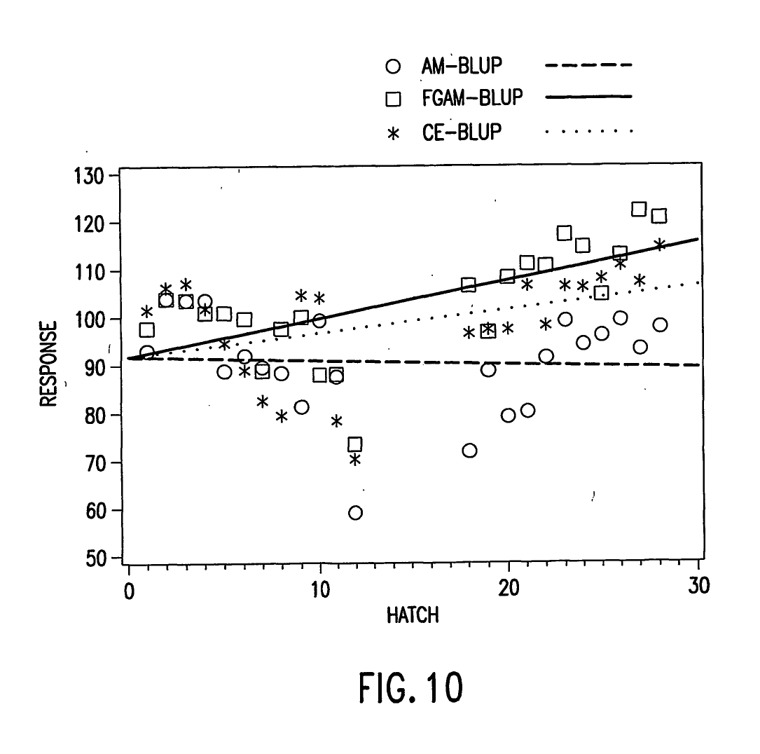

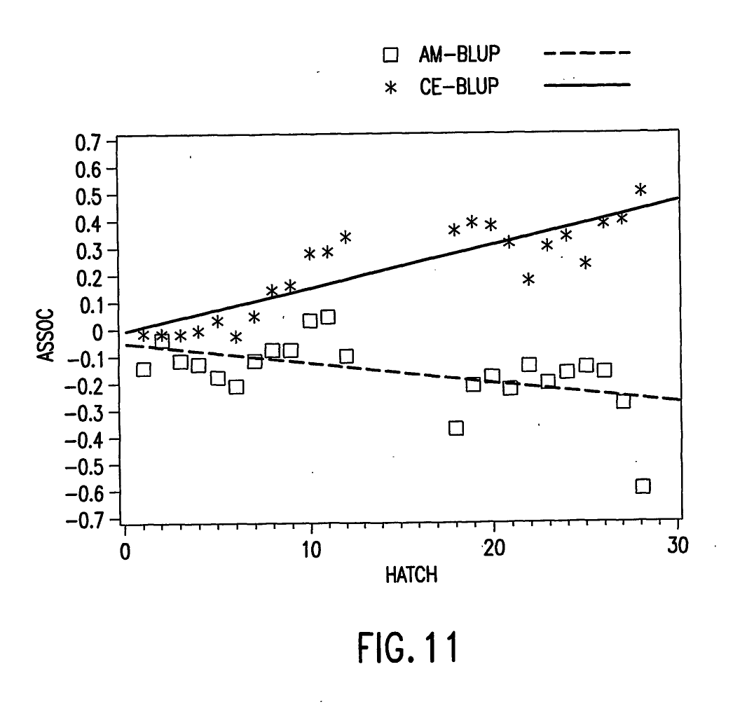

The raw data of 6 week weight by hatch and selection method is given in FIG. 10, showing the weight (g) of 6 week old quail by selection method and hatch. FIG. 11 shows associative effects from AM-BLUP and CE-BLUP.

TABLE 18
Statistical Analysis

| Method of | | | | Liner | | |
|---|---|---|---|---|---|---|
| Selection | Intercept | S.E. | Significance | Regression Coeff. | S.E. | Significance |
| CE-BLUP | 91.48 | 4.28 | <.0001 | 0.5130* | 0.253 | 0.05 |
| FGAM- | 91.77 | 3.66 | <.0001 | 0.7974*** | 0.216 | 0.001 |
| BLUP | | | | | | |
| AM-BLUP | 91.84 | 4.36 | <.0001 | −0.0742 | 0.258 | 0.776 |

Deviation from Traditional BLUP

| | | | | | | |
|---|---|---|---|---|---|---|
| CE-BLUP | −.3585 | 3.46 | 0.9185 | 0.5872** | 0.2046 | 0.01 |
| FGAM- | −.06612 | 3.69 | 0.9859 | 0.8716*** | 0.2184 | 0.001 |
| BLUP | | | | | | |

Results in FIG. 10 and Table 18 show that selection using AM-BLUP failed to give any response to selection and was in fact trending less than zero, but not significantly so. Both CE-BLUP and FGAM-BLUP were significantly better than AM-BLUP and resulted in significant genetic gains. By the last hatch, approximately 5 generations, the selected birds of FGAM-BLUP and CE-BLUP were 30% and 20% heavier than control, respectively. These results present dramatic proof that the incorporation of competitive effects in breeding programs results in significantly greater selection response.

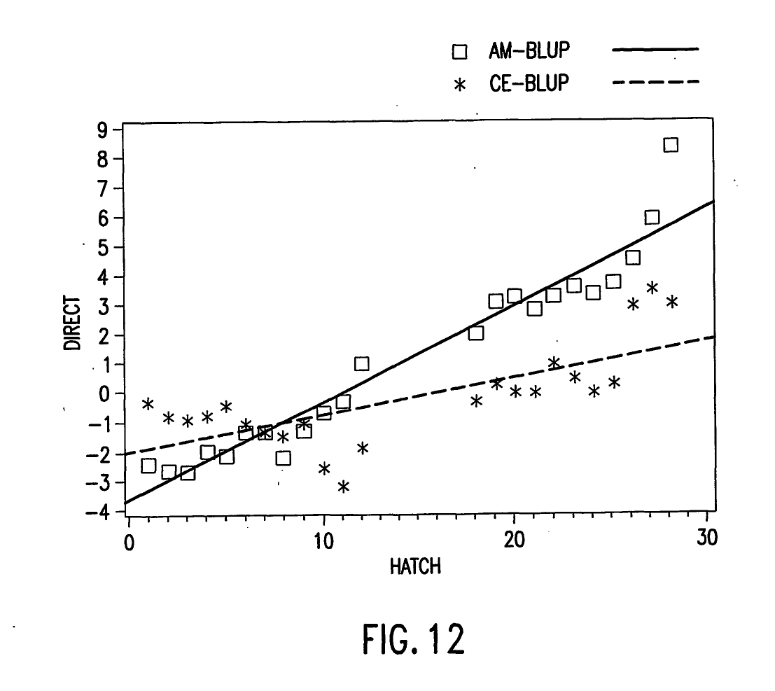

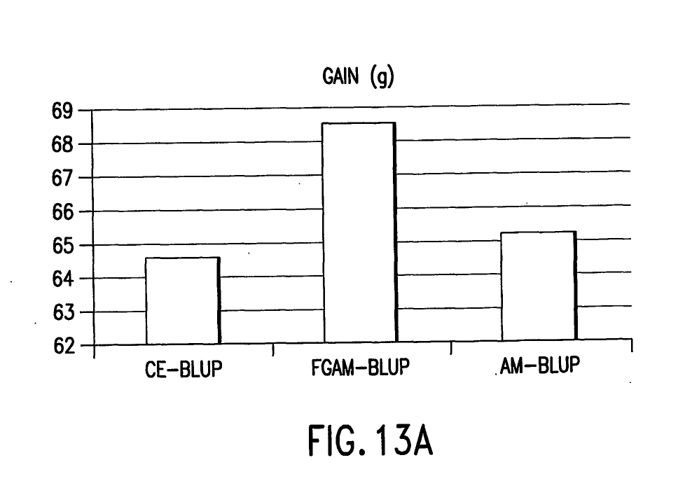

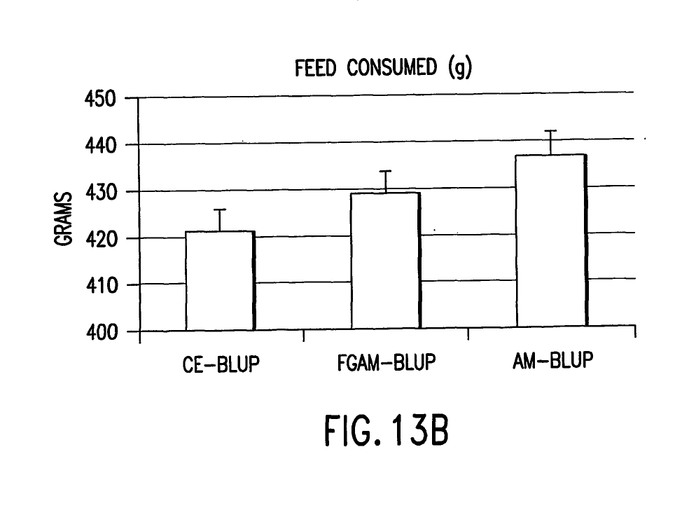

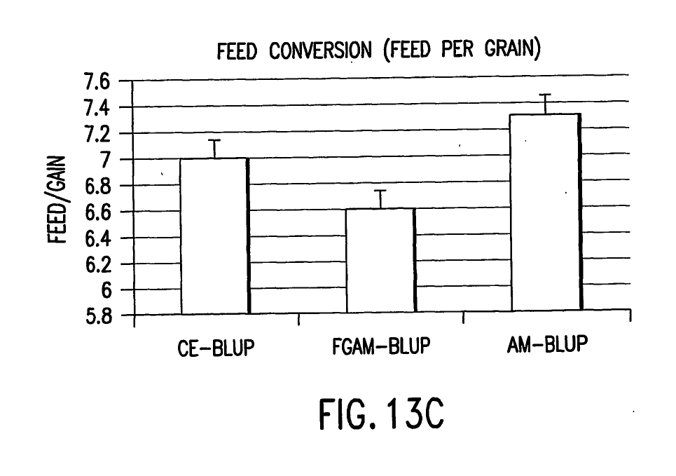

The lack of selection response to AM-BLUP is explained by examination of the direct and associative effects estimated using a CE-BLUP model. FIG. 12 shows associative effects from full and traditional BLUP. FIGS. 13A-C show the direct effects from use of CE and AM-BLUP. While AM-BLUP increased the direct effects, for 43 day weight, the Associative effects became increasingly negative. The net result was no genetic gain for performance achieved in the pens. In contrast, with selection based on CE-BLUP direct effects increased and associative effects became increasingly positive. A positive associative effect adds to the performance of cage mates whereas a negative associative effect detract from performance of cage mates. Thus, with AM-BLUP, the genetic potential and performance of birds reared in individual cages increased. However, the decrease in associative effects was so great with AM-BLUP selection, that the performance of the birds raised in pens did not increase. With CE-BLUP, increases in the growth performance of individual birds raised in pens was caused by the combined improvement in both direct and associative effects.

### Example 4

Impacts Group Selection on Feed Efficiency in Japanese Quail

One of the main costs of raising poultry is feed costs. The feed efficiency is an ongoing consideration. Feed wastage by the poultry increases in feed costs and decreases the feed efficiency. Beak length, feeder types, egg size and feed composition (i.e. protein composition) are just a few that have been shown to have an effect on feed efficiency. Beak length and egg size can be easily selected for. Feeders with less spillage possibility are a reasonable choice.

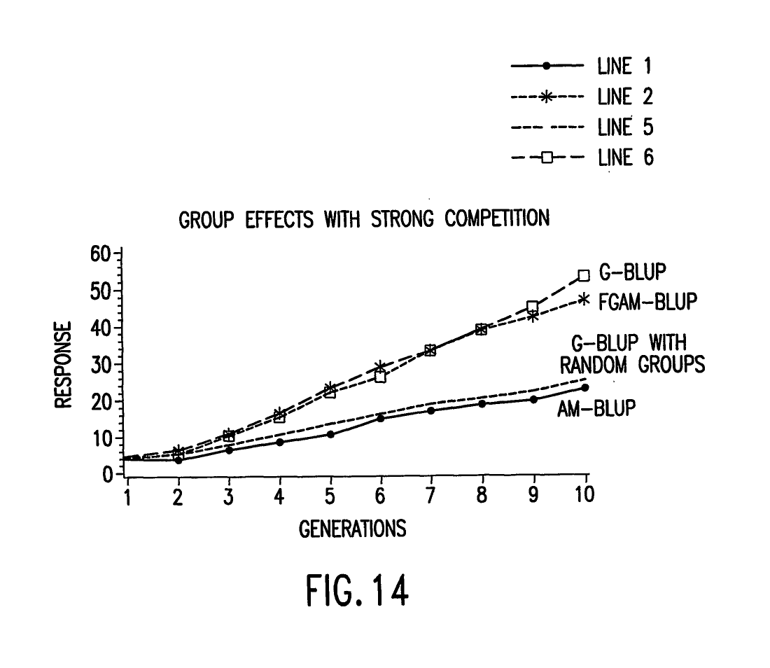

Each of the three lines was randomly mated in single pair breeding cages. Eggs were marked with the line designation. Offspring were only identified by a tracking number and the line designation. Offspring were randomized within each line and put 12 to a cage in a brooder room for two weeks after hatching. The chicks were then weighed and placed in growing cages with 12 random chicks of the same line, to a cage feed was not restricted. The feed presented to each cage was weighed and only replaced when the feeders were almost empty. At six weeks feed was removed 24 hours prior to the chicks being euthanized by carbon dioxide gas and frozen. The chicks were then weighed. Due to limitation of the number of offspring from the parent stock, three sets of the three lines were completed using the same-incubator, brooders and growing cages. All feeders and waterers were identical. Temperature and photoperiods were kept the same for all test subjects. Individual lines were not allowed to be next to each other in the cages. Results can be seen in FIGS. 14A, B and C.

The AM-BLUP selection program resulted in the greatest feed consumed combined with intermediate growth. This resulted in the worst feed conversion efficiency. The FGAM-BLUP selection program resulted in the greatest weight gain with intermediate feed consumption, resulting in the best feed conversion efficiency. The CE-BLUP selection program resulted in the least feed consumed while only intermediate weight gain and resulting in a 5% increase in feed conversion efficiency.

The 10% improvement in feed efficiency of the FGAM-BLUP selection program resulted from a large increase in weight gain with only a moderate increase in feed consumption.

The improvements in feed conversion efficiency is most likely due to a reduction in fighting and energy lost to maintain peck order and other social vice, however, this hypothesis has not been tested. However, evidence from within line uniformity support this hypothesis. The within line variance is an indirect measure of the amount of competition in a population. The within line variance in the EM-, FGAM- and AM-BLUP lines were respectively 5.45, 3.16 and 8.46. These within lines variance shows that the FGAM-BLUP line was the most uniform in feed efficiency and AM-BLUP line the least uniform, indicating that the AM-BLUP line is the most competitive, and the FGAM-BLUP line the least competitive.

Although this study was done with quail, equivalent results would be expected with any species with similar degree of competitive effects. For example, in swine, the economic impact of a 10% change in feed conversion can be determined based on the following assumption: at 200 lb live weight gain and 3.4 f/g and 6.5 cents per lb—the cost to grow this animal is $ 44.20. A 10% post weaning feed cost savings is $4.42 which is approximately the average profit per pig in today's more mature industry, thus producing a 100% increase in profitability

### Example 5

Computer Simulation of G-BLUP

| The following simulations compared: | |
|---|---|
| A) Two group structures were examined: Random and Half sib. | |
| B) Two intensities of competition, strong, and mild. | |
| Genetic parameters for strong competitive effect were: | |
| Additive genetic variance of associative effects | .5 |
| Additive genetic variance of direct effects | 40.0 |
| Additive covariance between direct and associative effects | −.05 |
| Genetic parameters for mild competitive effects were | |
| Additive genetic variance of associative effects | .125 |
| Additive genetic variance of direct effects | 10.0 |
| Additive covariance between direct and associative effects | −.05 |

The population size was 1200 per generation, equally divided between males and females with 30 males and 600 females selected per generation. Each female produced 2 offspring. Group size was 40. Half-sib families consisted of 10 full-sib families, 2 sib per family.

Selection was based only on BLUP. For group selection, all individuals in a group were assigned the mean of the group to which they were in (G-BLUP) For individual selection either AM-BLUP or FGAM-BLUP were used.

Results

Strong Competition:

Group performance (FIG. 14) shows that group performance improves equally well with G-BLUP group selection, or individual selection with animals housed in family groups for both cases. AM-BLUP selection or G-BLUP selection with animals housed in random groups showed minimal improvement

Weak Competition:

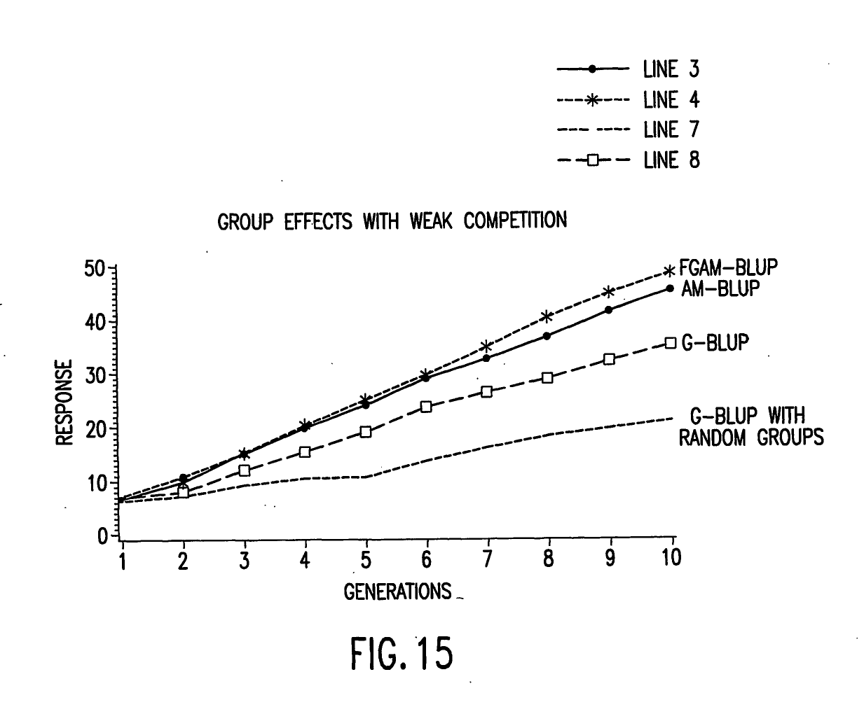

Group performance, (FIG. 15) shows that group performance improves equally well for individual selection, housed in either random groups or family groups, with pure groups selection inferior to individual selection. In the latter generation, individual selection with individuals housed in family groups was significantly better than individual selection in random groups.

Conclusion:

The optimal selection program and group structure is dependent on the intensity of the competitive effects. In both cases, housing animal in family groups was superior to random groups. With strong competitive effects, G-BLUP group selection is optimal. With weak competitive effects, the optimal program is individual selection in family groups (FGAM-BLUP).

### Example 6

Poultry Broilers or Ducks

Mate 500 males each of 4 females. Collect eggs for 2 weeks. Hatch 20,000 chicks (50% male and females). Wing band on hatching. House 20,000 chicks by half sib family at 20 weeks of age in each of 1000 floor pens (20 in a group, mixed sex). Weigh and record pen weight after brooding (2 weeks of age). Monitor and record feed consumption per pen and weight pen again at 6 weeks of age). Summarize data by pen and assign pen mean performance to each individual in the pen. Then use mixed model equations to obtain FGAM-BLUP breeding values for weight gain and feed consumption for each male and female. Select best 2,000 hens and 200 males based on index of two traits for breeding. Repeat procedure.

### Example 7

Swine

Individual group selection: Mate 20 different males to each of 4 different females every 2 weeks. Ear tag on birth. After weaning, weight and record weight for each pig and place 18 pigs from the same sire family in the same pen into each of 20 pens. The 20 pens forms a contemporary group. Every 2 weeks another contemporary group of 20 pens is formed. Monitor feed consumption on a pen basis. At 180 days of age, weigh and record pig weights. Summarize feed consumption data by pen and assign pen mean performance to each individual in the pen. Use individual weight gain as second trait. Then use mixed model equations to obtain FGAM-BLUP breeding values for weight gain and feed consumption for each male and female. Combine breeding values for weight gain and feed consumption using an index. Among the original 20 boars, replace any which have a lower index value with boars from the current contemporary group that have a higher value. Similarly, among the original 80 sows, replace any which have a lower index value with gilts from the currently contemporarily group with higher index values. Repeat procedure every 2 weeks.

### Example 8

Swine

Full-group selection: Mate 20 different males to each of 4 different females every 2 weeks. Ear tag on birth. After weaning, weight and record weight for each pig and randomly place 18 pigs from different sire families in the same pen into each of 20 pens. The 20 pens forms a contemporary group. Every 2 weeks another contemporary group of 20 pens is formed. At 180 days of age, weigh and record pig weights. For the trait weight gain, use the full CE-BLUP mixed model equations to obtain predicted breeding values OREV) for direct and associate effects on each pig. Combine breeding values for direct and associative effects using an index. Among the original 20 boars, replace any which have a lower index value with boars from the current contemporary group with a higher value. Similarly, among the original 80 sows, replace any which have a lower index value with gilts from the currently contemporarily group with higher index values. Repeat procedure every 2 weeks.

### Example 9

Aguaculture: Lobsters, Prawns, Walleye, Tilapia

Single pair mate 200 males each to 200 females to form a contemporary group. Collect eggs from each mating, hatch, and collect 100 fry from each mating. Split the fry from each mating into two group and place 50 fry into each of 400 tanks. At market weight, count and weigh individually or en mass, and tag with ID. Then use mixed model equations to obtain FGAM-BLUP breeding values for market weight. Among the original 200 males, replace any which have a lower index value with males from the current contemporary group with a higher value. Similarly, among the original 200 females, replace any which have a lower index value with females from the currently contemporarily group with higher index values. Repeat procedure

### Example 10

Aquaculture: Lobsters, Prawns, Walleye, Tilapia

Single pair mate 200 males each to 200 females to form a contemporary group. Collect eggs from each mating, hatch, and collect 100 fry from each mating. Split the fry from each mating into two group and place 50 fry into each of 400 tanks. At market weight, count and weigh en mass. Summarize data by tank and assign tank mean performance to each individual in the tarn. Then use mixed model equations to obtain G-BLUP breeding values for market weight Select highest producing groups based on G-BLUP solution. Tag individuals from selected groups. Repeat procedure.

### Example 11

Poultry Layers

Mate 500 males each of 4 females. Collect eggs for 2 weeks. Hatch 20,000 chicks (50% male and females). Wing band on hatching. House 10,000 pullets by half sib family at 20 weeks of age in each of 1,000 group cages (10 in a group). Keep 2 cockerels from each hen and place in separate facility. Collect, count and-weigh eggs from each cage for 40 weeks. At end of 40 weeks of production, summarize data by cage and assign group mean performance to each individual in the group. For roosters, include in analysis with pedigree but missing values for performance. Then use mixed model equations to obtain G-BLUP breeding values for egg number and egg weight each male and female. Select best 2,000 hens and 200 males based on index of two traits for breeding. Repeat procedure.

### Example 12

Forestry

For a stand of trees, measure yield of each tree and determine pedigree either from designed matings or construct relationship matrix using DNA markers. Assume a tree only competes with trees that immediately surround it. For each tree in a stand, create the associative effects incidence matrix to reflect all trees which interact Solve for direct and associative effect using the full CE-BLUP mixed model. Select for trees which have high direct effects but low associative effects, i.e. grow fast and are non competitive for space and nutrients.

Bibliography

Barlow, R 1981. Experimental evidence for interaction between heterosis and environment in animals. Anim. Breed Abst. 49:715-737.

Bennett, G. L., G. E. Dickerson, and T. S. Kashyap. 1981. Effectiveness of progeny test index selection for filed performance of strain-cross layers. II. Predicted and realized responses. Poultry Sci. 60:22-33.

Bichard, M. and W. C. Smith. 1972. Crossbreeding and genetic improvement In Pig Production (ed D. J. A. Cole), p. 37-52. Butterworths,London.

Biswas, D. K. and J. V. Craig. 1970. Genotype-environment interactions in chickens selected for high and low social domlinance. Poultry Sci. 49:681-696.

Botermans, J., M. Andersson, and J. Svendsen 1995. Growing-finishing pigs in an uninsulated house .1. Pig performance and health and the influence of rearing system. Swedish Journal of Agricultural Research. 25: (2) 73-82.

Brunm, M. C. and P. S. Miller. 1996. Response of pigs to space allocation and diets varying in nutrient density. Journal of Animal Science. 74: (11) 2730-2737.

Brumm, M. C. and NCR-89 Committee. 1996. Effect of space allowance on barrow performance to 136 kilograms body weight J. AnimL Sci. 74:745-749.

Busse, C. S. and M. M. Shea-Moore. 1999. Behavorial and physiological responses to transportation stress in three genetic lines of pigs. J. Anim. Sci. 77(suppl 1):147.

Cameron, N.D. 1997. Selection indices and prediction of genetic merit in animal breeding. CAB International New York N.Y.

Chapple, R. P. 1993. Effect of stocking arrangement of pig performance. Manipulating Pig Production IV. p. 87-97.

Choudary, M. R., A. W. Adams, and J. V. Craig. 1972. Effects of strain, age of flock assembly, and cage arrangement on behavior and productivity on White Leghorn type chickens. Poultry Sci. 51:1928-1937.

Clark, L. K, A. B. Schedit, C. N. Armstrong, K Knox, and V. B. Mayrose. 1991. The effect of all-in/all-out management on pigs from a herd with enzootic pneumonia. Vet. Med. 86:946.

Cline, T. R., V. B. Mayrose, A. B. Scheidt, M. A. Diekman, L. K. Clark, C. S. Hurt, and W. L. Singleton. 1994. Effect of all-in/all-out management on the performance and health of growing-finishing pigs. 1994 Purdue Swine Day Report p.9-12.

Consortium, 1988. Guide for the care and use of agricultural animals in agricultural research and teaching. Association Headquarters, 309 W. Clark, Champaign, Ill.

Craig, J. V. and W. M. Muir. 1993. Selection for reduction of beak-inflicted injuries among caged hens. Poultry Science. 72: (3) 411-420.

Craig, J. V. and W. M. Muir. 1996. Group selection for adaptation to multiple-hen cages: beak-related mortality, feathering, and body weight responses. Poultry Science. 75:(3) 294-302.

Craig, J. V., W. M. Muir and F. L. Kuo. 1991. Selection and beak-trimming effects on behavior, cannibalism, and short-term production traits in white leghorn pullets. Poultry Science. 70: (5) 1057-1068.

Craig, J. V. 1970. Interactions of genotye and housing envirornent in chickens selected for high and low social dormiance ability. Proc. 14th World's Poultry Congress, Madrid 2:37-42.

Craig, J. V. 1982. Behavioral and genetic adaptation of laying hens to high-density environments. Bioscience. 32:33-37.

Craig, J. V. 1994. Genetic influences on behavior associated with well-being and productivity in livestock. Proc. 5th World Congress of Genetics Applied to Livestock Breeding.

Craig, J. V. and A. Toth 1969. Productivity of pullets influenced by genetic selection for social dominance ability and by stability of flock membership. Poultry Sci. 48:1729-1736.

Craig, J. V. and H. Y. Lee, 1989. Research note: Genetic stocks of White Leghorn type differ in relative productively when beaks are intact versus trimmed. Poultry Sci. 68:1720-1723.

Craig, J. V., A. D. Dayton, V. A. Garwood, and P. C. Lowe. 1982. Selection for egg mass in different social environments. 4. Selection response Phase I. Poultry Sci. 61:1786-1796.

Craig, J. V., L. L. Ortman, and A. M. Guhl. 1965. Genetic selection for social dominance ability in chickens. Anim. Behav. 13:114-131

Craig, J. V., M. L. Jan, C. R. Polley, and A. L. Bhagwat 1975. Changes in relative aggression and social dominance associated with selection for early egg production in chickens. Poultry Sci. 54:1647-1658.

Crow, J. F. and M. Kimura. 1970. An introduction to Population Genetics Theory. Chapter 5: Selection. Harper and Row, New York.

Ekkel, E. D., B. Savenije, W. G. P. Schouten, and M. J. M Tielen. 1996. Health, welfare, and productivity of pigs housed under specific-stress-free conditions in comparison with two-site systems J. Anim. Sci. 74: (9) 2081-2087.

Emsley, A., G. E. Dickerson, and T. S. Kashyap. 1977. Genetic parameters in progeny-test selection for filed performance of strain-cross layers. Poultry Sci. 56:121-146.

Frank, G. R., M. E. Spurlock, S. G. Cornelius, G. M. Willis, and M. McComb. 1997a. Effects of group size on performance, fat depth and serum concentrations of insulin-like growth factor-1 in grow-finishing pigs. J. Anim. Sci. Vol. 75(Suppl. 1):37(abstr.).

Frank, J. W., B. T. Richert, A. P. Schinckel, B. A. Belstra, and A. L. Grant 1997b. Environmental effects on genetic potential for lean gain. J. Anim. Sci.(Suppl. 1):38(abstr.).

Giersing, M. H. and M. Studnitz. 1996. Characterization and investigation of aggressive behaviour in the pig. Acta Agriculturae Scandinavica Section A-Animal Science 56-60, Suppl. 27.

Gonyou, H. W. 1994. Why the study of animal behavior is associated with the animal-welfare issue. J. Anim. Sci. 72: (8) 2171-2177.

Goodnight, C. J. 1985. The influence of environmental variation on group and individual selection in cress. Evolution 39:545-558.

Griffing, B. 1967. Selection in reference to biological groups. I. Individual and group selection applied to populations of unordered groups. Aust J. Biol. Sci., 10: 127-139.

Griffing, B. 1976. Selection in reference to biological groups. V. Analysis of full-sib groups. Genetics 82:703-722.

Hamilton, W. D., 1964. The genetic evolution of social behavior. J. Theoret Biol. 7: 1-16.

Hathaway, M. R., W. R. Dayton, B. Wiseman, T. Molitor and M. E. White. 1993. Effect of weaning pigs at 10 days to off-site clean nurseries on growth rate, IGF-1 levels and serum mitogenic activity. J. Anim. Sci. 71(Suppl. 1, abstr.);43.

Hessing, M. J. C., G. J. Coenen, M. Vaiman, C. Renard. 1995. Individual differences in cell-mediated and humoral immunity in pigs. Vet Ibmunol. Immunopathol. 45:97-113.

Hessing, M. J. C. C. J. M. Scheepens, W. G. P. Schouten, M. J. M. Tielen, P. R. Wiepkema 1994. Social Rank And Disease Susceptibility In Pigs Veterinary lmmunology And Immunopathology 43: (4) 373-387

Hester, P. Y., W. M. Muir, J. V. Craig, and J. L. Albright, 1995a. Group selection for adaptation to multiple-hen cages: Response to social and cold stress. Poultry Sci.

Hester, P. Y., W. M. Muir, J. V. Craig, and J. L. Albright, 1995b. Group selection for adaptation to multiple-hen cages: Response to social and heat stress. Poultry Sci.

Hester, P. Y., W. M. Muir, and J. V. Craig, 1995c. Group selection for adaptation to multiple-hen cages: Immunological response to social, cold, and heat stress. Poultry Sci.

Hester, P. Y., W. M. Muir, and J. V. Craig. 1996a. Group selection for adaptation to multiple-hen cages: Humoral immune response. Poultry Sci., 75:1315-1320.

Hester, P. Y., W. M. Muir, J. V. Craig, and J. L. Albright 1996b. Group selection for adaptation to multiple-hen cages: Production traits during heat and cold exposure. Poultry Sci. 75:1295-1307.

Holck, J. T., A. P. Schinckel, J. L. Coleman, V. M. Wilt, E. L. Thacker, M. Spurlock, A. L. Grant, P. V. Malven, M. K. Senn, and B. J. Thacker. 1997. Environmental effects on the growth of finisher pigs. Vol. 75(Suppl. 1):246(abstr.).

Jensen, K H., N. Oksbjerg, E. Jorgensen. 1994. Salbutamol and level of protein-effects on the acute stress-response in pigs. Physiology & Behavior. 55:(2)375-379.

Kashyap, T. S., G. E. Dickerson, and G. L. Bennett 1981. Effectiveness of progeny test multiple trait index selection for filed performance of strain-cross layers. I. Estimated responses. Poultry Sci. 60:1-21.

Kennedy, G. W. and M. Quinton. 1987. A note on the effects of health environment on heterosis for growth rate in pig. Anim. Prod. 44:443-445.

Komegay, E. T. and D. R. Notter. 1984. Effects of floor space and number of pigs per pen on performance. Pig News and Info., 5:23-33.

Kuo, F. L., J. V. Craig, and W. M. Muir, 1991. Selection and beak-trimming effects on behavior, canmnbalism, and short-term production traits in White Leghorn pullets. Poultry Sci. 70:1057-1068.

Lee, Y. -P., and Craig, J. V. (1981a). Agonistic and nonagonistic behaviors of pullets of dissimilar strains of White Leghorns when kept separately and intermingled. Poultry Sci. 60, 1759-1768.

Lee, Y.-P, and Craig, J. V. (1981b). Evaluation of egg-laying stains of chickens in different housing environments: role of genotype by environment interactions. Poultry Sci. 60, 1769-1781.

Lee, H. J. and J. V. Craig. 1991. Beak tnmming effects on behavior patterns, fearfulness, feathering, and mortality among three stocks of White Leghorn pullets in cages and floor pens. Poultry Sci. 70:211-221.

Lee, H. -Y. and J. V. Craig. 1990. Beak tiimniing effects on behavior and weight gain of floor-reared, egg-strain pullets of three genetic stocks during the rearing period. Poultry Sci. 69:568-575.

Lowry, D. C. and H. Abplanalp. 1970. Genetic adaptation of White Leghorn hens to life in single cages. Br. Poultry Sci. 11:117-131.

Lowry, D. C. and H. Abplanalp. 1972. Social dominance differences, given limited access to common food, between hens selected and unselected for increased egg production. Br. Poultry Sci. 13:365-376.

Lynch, M. and B. Walsh. 1997. Genetics and analysis of quantitative traits. Br. Poultry Sci., 13:365-376.

McComb, M. A., J. W. Frank, A. P. Schinckel, M. E. Spurlock, B. T. Richert, P. J. Malven and A. L. Grant 1997. Interactive effects of rearing environment, pig genotype and antibiotic therapy on growth, serum IGF-1 and acute phase proteins. J. Anim. Sci. Vol. 75(Suppl.1):85(abstr.).

Moberg, G. P. 1987. A model for assessing the impact of behavioral stress on domestic animals. J. Anim. Sci., 65:1228-1235.

Moberg, G. P. 1993. A review-developing management strategies to reduce stress in pigs: a new approach utilizing the biological cost of stress. In Manipulating Pig Production IV. (E. W. Butterham, Ed.) Aust. Pig Sci. Assoc. Ahwood, Victoria, Aust p. 116.

Moberg, G. P. 1987. A model for assessing the impact of behavioral stress on domestic animals. J. Anim. Sci. 65:1228-1235.

Mrode, R. A. 1996. Linear models for the prediction of animal breeding values. CAB International. New York N.Y.

Morrowtesch, J. L., J. J. Mcglone, and J. L. Salakjohnson. 1994. Heat and social stress effects on pig immune measures. J. Anim. Sci.. 72:(10)2599-2609.

Muir, W. M. 1985. Relative efficiency of selection for performance of birds housed in colony cages based on production in single bird cages. Poultry Sci. 64:2239-2247.

Muir, W. M. and D. L. Liggett, 1995b. Group selection for adaptation to multiple-hen cages: Comparisons with a control and commercial lines. Poultry Sci.

Muir, W. M. 1996. Group selection for adaptation to multiple-hen cages: Selection program and direct responses. Poultry Sci. 75:447-458

Muir, W. M. and J. V. Craig. 1998. Improving Animal Well-Being Through Genetic Selection. Poultry Sci. 77:1781-1788.

Noyes, E. P., A. Feeney and C. Pijoan. 1990. Comparison of the effect of pneumonia detected during lifetime with pneumonia detected at slaughter on-growth in swine. J. Amer. Vet. Med. Assoc. Vol. 197:1025-1032.

NPPC. 1991. Procedures to evaluate market hogs (3rd Ed.). National Pork Producers Council Des Moines, Iowa.

Olesen, L. S., C. M. Nygaard, T. H. Friend, D. Bushong, D. A. Knabe, K S. Vestergaard, and R. K Vaughan. 1996. Effect of partitioning pens on aggressive behavior of pigs regrouped at weaning. Applied Animal Behavior Science. 46: (3-4) 167-174

Pajor, E. A., C. Busse, S. Torrey, M. Shea-Moore, and T. Stewart. 2000. The effect of selection for lean growth on swine behavior and welfare. Purdue Swine Day Reports. pp 1-3.

Powell, T. A., and M. C. Brumm. 1992. Economics of space allocation for grower-fimisher hogs. J. Am. Soc. Farm Mgrs. Rural Appraisers 56(1):67.

Scheidt, A. B., V. B. Mayrose, W. G. VanAlstine, L. K. Clark, T. R. Cline, and M. E. Einstein. 1992. The benefit cost of vaccinating pigs for mycoplasmal pneumonia. 1994 Purdue Swine Day Report. p.13.

Schinckel, A. P. 1994a. Nutrient requirements of modern pig genotypes. In (Gamsworthy, P. C. and D. J. A. Cole Ed.): Recent advances in animal nutrition. Univ. of Nottingham Press, Nottingham, U.K. p.133.

Schrama, J. W., J. M. Schouten, J. W. G. M. Swinkels, J. L. Gentry, G. de Vries Reilingh, and H. K. Parmentier. 1997. Effect of hemoglobin status on humoral immune response of weanling pigs differing in coping styles. J. Anim. Sci., 75:2588-2596.

Shea-Moore, M. M. 1999. The effect of genotype on behavior in segregated early-weaned pigs tested in an open field. J. Anim. Sci. (suppl.1):100.

Siegel, P. B. 1989. The genetic-behavior interface and well-being of poultry. British Poultry Sci. 30:3-13.

Skirrow, S. Z. 1993. Effects of stocking arrangements on respiratory disease on pigs. In Manipulating Pig Production IV (u.S. Batterham Ed.). Aust Pig Sci. Assoc. Ahwood Victoria, Aust p. 98.

Staly, T. S., N. H. Williams and S. G. Swenson. 1994. Interactive effects of immune system activation and lean growth genotype on growth of pigs. Iowa State Univ. 1994 Swine Research Reports. p. 33-35.

Swanson, J. C. 1995. Farm animal well-being and intensive production systems. J. Anim. Sci. 73 :(9)2744-2751.

Torrey, S., S. Weaver, E. Pajor, D. Kuhlers, and T. Stewart 2000. Evaluating differences in stress levels in lean growth versus control Landrace pigs. Purdue University Swine Day Report pp 4-10.

Van Kessel, A. G., A. Estrada, J. F. Patience, M. Tang and B. Coarveld. 1997. Toward defining the physiological and immunological mechanisms mediating improved performance in site-segregated early weaned pigs. J. Anirn. Sci. 75(Suppl. 1): 169(abstr.).

Wiegand, R. M., H. W. Gonyou, and S. E. Curtis1994. Pen shape and size-effects on pig behavior and performance. Applied Animal Behavior Science. 39: (1) 49-61

Williams, N. H., T. S. Stahly, and D. R. Zimmerman. 1993. Impact of inmmune system activation and dietary amino acid regimen on nitrogen retention of pigs. J. Anim. Sci. 71(Suppl. 1):171.

What is claimed is:

1. A method for breeding animals which comprises the steps of:
(a) Determining one or more desired traits for improvement;
(b) Identifying a population or line,.with a known or unknown pedigree, which is to be improved;
(c) Mating a male to a single female or to multiple females to produce first generation offspring;
(d) Uniquely identifying some or all of said first generation offspring as to parentage and establishing a pedigree database;
(e) Grouping said first generation offspring into one or more common areas, by family as mated in step (c) at a desired density, without employing management practices which limit competitive effects;
(f) Collecting performance data for said desired traits at one or more desired ages for one or more of said individual first generation offspring and establishing a performance database;
(g) Developing for one or more of said traits a mixed statistical model which associates performance data of step (f) with identified fixed effects and random effects for direct effects of said individual first generation offspring, random environmental effects and all relationships of said offspring of step (d);
(h) Estimating genetic parameters for each of said desired traits based on the performance data of step (f), the pedigree of step (d) and the mixed statistical model of step (g);
(i) Determining individual first generation offspring to be selected for breeding using the performance data of step (f), the estimated genetic parameters (h), the pedigree of step (d), and the mixed statistical model of step (g);
(j) Breeding some or all of said selected first generation offspring of step (i) by mating a male to a single female or to multiple females to produce second generation offspring;
k) Uniquely identifying some or all of said individual second generation offspring of step (j) as to parentage and updating the pedigree database;
(l) Grouping said individual second generation offspring into one or more common areas, by family, as mated in step (j) at a desired density, without employing management practices which limit competitive effects;
(m) Collecting performance data for said desired traits for some or all of said individual second generation offspring;
(n) Optionally updating genetic parameters for each of said traits based on performance data base of step (m) and pedigree of step (k);
(o) Determining individual second generation offspring to be selected for breeding using performance data in step (m), estimated genetic parameters of step (h) or (n), pedigree in step (k), and model of step (g);
(p) Breeding some or all of said individual second generation offspring by mating one male to a single female or to multiple females to produce third generation offspring; and
(q) Repeating steps (k)-(p) until a desired improvement in said traits is achieved.

2. The method of claim 1, wherein said mixed statistical model uses best linear unbiased prediction (BLUP).

3. The method of claim 1, wherein said offspring of steps (e), (l) and (p) are grouped in defined groups under a selected environmental condition inducing competitive effects.

4. The method of claim 3, wherein the competitive effects are weak competitive effects.

5. The method of claim 3, wherein the competitive effects are strong competitive effects.

6. The method of claim 1, wherein said method is preformed by computer software executing on a computer.

7. A method for breeding animals which comprises the steps of:
(a) Determining one or more desired traits for improvement;
(b) Identifying a population or line, with a known or unknown pedigree, which is to be improved;
(c) Mating a male to a single female or to multiple females to produce first generation offspring;
(d) Uniquely identifying some or all of said first generation offspring as to parentage and updating pedigree database of step (b);
(e) Grouping said first generation offspring into one or more common areas, at random at a desired density, without employing management practices which limit competitive effects;
(f) Collecting performance data for said desired traits at one or more desired ages for one or more of said individual first generation offspring and establishing a performance database;
(g) Developing for one or more of said traits a mixed statistical model which associates performance data of step (f) with identified fixed effects and random effects for direct and associative effects of each first generation offspring, random environmental effects and all relationships of said offspring of step (d);
(h) Estimating genetic parameters for each of said desired traits based on the performance data of step (f), the pedigree of step (d) and the mixed statistical model of step (g);
(i) Incorporating genetic parameters into said mixed statistical model of step (g);
(j) Estimating direct and associative effects for said desired traits for said individual first generation offspring, using the performance data of step (f), the genetic parameters of step (h), the pedigree of step (d) and the mixed statistical model of step (g);
(k) Determining individual first generation offspring to be selected for breeding using the desired combination of direct and associative effects of step (j);
(l) Breeding some or all of said selected individual first generation offspring by mating a male to a single female or to multiple females to produce second generation offspring;
(m) Uniquely identifying some or all of said individual second generation offspring as to parentage and updating pedigree database of step (d);
(n) Grouping said individual second generation offspring into multiple common areas at random at a desired density, without employing management practices which limit competitive effects;
(o) Collecting performance data for said desired traits for some or all of -said individual second generation offspring and updating performance database of step (f);
(p) Optionally updating genetic parameters for each of said traits of step (h) based on performance database of step (o) and pedigree database of step (m);
(q) Optionally updating said mixed model equations of step (g) using updating estimates of parameters of step (p), updated performance database of step (o) and pedigree database of step (m);
(r) Estimating direct and associative effects for said desired traits for said individual s second generation offspring using said mixed statistical model of step (g) with said updated performance data base of step (o), and pedigree of step (m);
(s) Determining individual second generation offspring to be selected for breeding using the desired combination of estimated direct and associative effects of step (r);
(t) Breeding some or all of said individual second generation offspring by mating one male to a single female or to multiple females to produce third generation offspring; and
(u) Repeating steps (m)-(s) until a desired improvement in said traits is achieved.

8. The method of claim 7, wherein the direct and associative effects estimated in step r are weighted using an index to determine individual first generation offspring to be selected for breeding.

9. The method of claim 7, wherein said determination in steps (k) and (s) is performed using individual own performance (IOP).

10. The method of claim 7, wherein said determination of steps (k) and (s) is performed using best linear unbiased prediction (BLUP).

11. The method of claim 7, wherein said offspring of steps (e), (n) and (u) are grouped in a defined group of interacting individuals with management practices inducing competitive interactions.

12. The method of claim 11, wherein said competitive effects are weak competitive effects.

13. The method of claim 11, wherein said competitive effects are strong competitive effects.

14. The method of claim 7, wherein said method is performed by computer software executing on a computer.

15. A method for breeding animals which comprises the steps of:
(a) Determining one or more desired traits for improvement;
(b) Identifying a population or line, with a known or mi1mown pedigree, which is to be improved;
(c) Mating a male to a single female or to multiple females to produce first generation offspring;
(d) Grouping said first generation offspring into one or more common areas, by family as mated in step (c) at a desired density, without employing management practices which limit competitive effects;
(e) Collecting performance data for said desired traits at one or more desired ages collectively as a group to establish a performance database;
(f) Updating said pedigree of step (b);
(g) Developing for one or more of said traits a mixed statistical model which associates performance data of step (e) with identified fixed effects and random effects for direct effects of said individual first generation offspring, random environmental effects, and all relationships of said offspring of step (e);
(h) Estimating genetic parameters for each of said desired traits based on performance data of step (e), pedigree of steps (f), and mixed statistical model of step (g);
(i) Determining which of said group of step (e) to be selected for breeding using performance data of step (e), genetic parameters of step (h), pedigree of step (f), and mixed statistical model of step (g);
(j) Uniquely identifying and assigning permanent identification numbers for some or all of said individual second generation offspring in each of said selected group of step (i) as to parentage and updating pedigree;
(k) Breeding some or all of said selected individual offspring by mating a male to a single female or to multiple females to produce second generation offspring;
(l) Grouping said individual second generation offspring into one or more common areas, by family, as mated in step (k) at a desired density, without employing management practices which limit competitive effects;
(m) Collecting performance data for said desired traits at said desired ages, collectively as a group;
(n) Updating pedigree for said individual second generation offspring;
(o) Optionally updating genetic parameters for each of said traits based on performance data base of step (m) and pedigree of step (n);
(p) Determining which group of second generation offspring to be selected for breeding using performance data in step (m), estimated genetic parameters of step (o), pedigree in step (m), and model of step (g);
(q) Uniquely identifying and assigning permanent identification numbers for some or all of said individual second generation offspring in each of said selected group of step (i) as to parentage and updating pedigree;
(r) Breeding some or all of said individual second generation offspring by mating one male to a single female or to multiple females to produce third generation offspring;
(s) Repeating steps (k)-(q) until a desired improvement in said traits is achieved.

16. The method of claim 15, wherein said determination of steps (i) and (p) is performed using individual own performance (IOP).

17. The method of claim 15, wherein said determination of steps (i) and (p) is performed using best linear unbiased prediction (BLUP).

18. The method of claim 15, wherein said offspring of steps (d) and (l) are grouped under a management condition inducing competitive effects.

19. The method of claim 18, wherein the competitive effects are weak competitive effects.

20. The method of claim 18, wherein the competitive effects are strong competitive effects.

21. The method of claim 15, wherein said method is performed by computer software executing on a computer.

22. A method for breeding plants which comprises the steps of:
(a) Determining one or more desired traits for improvement;
(b) Identifying a population or line, with a known or unknown pedigree, which is to be improved;
(c) Mating a male to a single female or to multiple females to produce first generation offspring;
(d) Uniquely identifying some or all of said first generation offspring as to parentage and updating pedigree database of step (b);
(e) Grouping said first generation offspring into one or more common areas, at random at a desired density, without employing management practices which limit competitive effects;
(f) Collecting performance data for said desired traits at one or more desired ages for one or more of 9-said individual first generation offspring and establishing a performance database;
(g) Developing for one or more of said traits a mixed statistical model which associates performance data of step (f) with identified fixed effects and random effects for direct and associative effects of each first generation offspring, random environmental effects and all relationships of said offspring of step (d);
(h) Estimating genetic parameters for each of said desired traits based on the performance data of step (f), the pedigree of step (d) and the mixed statistical model of step (g);
(i) Incorporating genetic parameters into said mixed statistical model of step (g);
(j) Estimating direct and associative effects for said desired traits for said individual first generation offspring, using the performance data of step (f), the genetic parameters of step (h), the pedigree of step (d) and the mixed statistical model of step (g);
(k) Determining individual first generation offspring to be selected for breeding using the desired combination of direct and associative effects of step (j);
(l) Breeding some or all of said selected individual first generation offspring by mating a male to a single female or to multiple females to produce second generation offspring;
(m) Uniquely identifying some or all of said individual second generation offspring as to parentage and updating pedigree database of step (d);
(n) Grouping said individual second generation offspring into multiple common areas at random at a desired density, -without employing management practices which limit competitive effects;
(o) Collecting performance data for said desired traits for some or all of said individual second generation offspring and updating performance database of step (f);
(p) Optionally updating genetic parameters for each of said traits of step (h) based on performance database of step (o) and pedigree database of step (m);
(q) Optionally updating said mixed model equations of step (g) using updating estimates of parameters of step (p), updated performance database of step (o) and pedigree database of step (m);
(r) Estimating direct and associative effects for said desired traits for said individual second generation offspring using said mixed statistical model of step (g) with said updated performance data base of step (o), and pedigree of step (m);
(s) Determining individual second generation offspring to be selected for breeding using the desired combination of estimated direct and associative effects of step (r);
(t) Breeding some or all of said individual second generation offspring by mating one male to a single female or to multiple females to produce third generation offspring; and
(u) Repeating steps (m)-(s) until a desired improvement in said traits is achieved.

23. The method of claim 22, wherein said determination in steps (k) and (s) is performed using individual own performance (IOP).

24. The method of claim 22, wherein said determination of steps (k) and (s) is performed using best linear unbiased prediction (BLUP).

25. The method of claim 22, wherein said offspring of steps (e) and (l) are grouped in a defined group of interacting individuals with management practices inducing competitive interactions.

26. The method of claim 25, wherein said competitive effects are weak competitive effects.

27. The method of claim 25, wherein said competitive effects are strong competitive effects.

28. The method of claim 22, wherein said method is performed by computer software executing on a computer.

29. A breeding method, comprising the steps of:
(a) Randomly assigning individuals to groups;
(b) Measuring trait performance for said individuals;
(c) Selecting individuals for breeding based on a mixed model comprising two random effects, one for the direct effect of the individual and another for associative effect of other individuals in the group; and
(d) Breeding said selected individuals of step (c) or their relatives.

30. A breeding method, comprising the steps of:
(a) Assigning related individuals to family groups;
(b) Measuring trait performance for said individuals;
(c) Selecting individuals for breeding based on a mixed model comprising one random effect for the direct effect of the individual;
(d) Breeding said selected individuals of step (c) from said family groups or their relatives.

31. A breeding method, comprising the steps of:
(a) Assigning related individuals to family groups;
(b) Measuring trait performance collectively as a group;
(c) Selecting groups for breeding based on group performance data, and a mixed model comprising one random effect for the group mean; and
(d) Breeding individuals of said selected groups of step (c).
